(19) United States
(12) Patent Application Publication
(10) Pub. No.: US 2017/0076194 A1
(43) Pub. Date: Mar. 16, 2017

(54) APPARATUSES, METHODS AND SYSTEMS FOR DEFINING HARDWARE-AGNOSTIC BRAINS FOR AUTONOMOUS ROBOTS

(71) Applicant: Neurala, Inc., Boston, MA (US)

(72) Inventors: Massimiliano Versace, Boston, MA (US); Roger Matus, Waltham, MA (US); Alexandrea Defreitas, Warwick, RI (US); John Michael Amadeo, Mont Vernon, NH (US); Tim Seemann, Brookline, MA (US); Ethan Marsh, Allston, MA (US); Heather Marie Ames, Boston, MA (US); Anatoli GORCHETCHNIKOV, Newton, MA (US)

(21) Appl. No.: 15/343,673

(22) Filed: Nov. 4, 2016

Related U.S. Application Data
(63) Continuation of application No. PCT/US2015/029438, filed on May 6, 2015.
(60) Provisional application No. 61/989,332, filed on May 6, 2014.

(51) Int. Cl. G06N 3/00; G06N 3/08; G06N 3/04

(52) U.S. Cl. CPC G06N 3/008; G06N 3/04; G06N 3/08

(57) ABSTRACT

Conventionally, robots are typically either programmed to complete tasks using a programming language (either text or graphical), shown what to do for repetitive tasks, or operated remotely by a user. The present technology replaces or augments conventional robot programming and control by enabling a user to define a hardware-agnostic brain that uses Artificial Intelligence (AI) systems, machine vision systems, and neural networks to control a robot based on sensory input acquired by the robot's sensors. The interface for defining the brain allows the user to create behaviors from combinations of sensor stimuli and robot actions, or responses, and to group these behaviors to form brains. An Application Program Interface (API) underneath the interface translates the behaviors' inputs and outputs into API calls and commands specific to particular robots. This allows the user to port brains among different types of robot to robot without knowing specifics of the robot commands.

### CROSS-REFERENCE TO RELATED APPLICATION

This application is a bypass continuation of International Application No. PCT/US2015/029438, which was filed on May 6, 2015, and which in turn claims priority, under 35 U.S.C. §119(e), from U.S. Application No. 61/989,332, filed May 6, 2014, and entitled “Apparatuses, Methods, and Systems for Defining Hardware-Agnostic Brains for Autonomous Robots.” Each of these applications is hereby incorporated herein by reference in its entirety.

### BACKGROUND

Conventionally, robots are typically programmed to complete tasks using a text or graphical programming language, shown what to do for repetitive tasks (e.g., as in the case of the Rethink Robotics Baxter), or operated remotely by a user. Each interface is typically specific for a type of robot or robot operating system, is often tailored to a specific task, and does not scale past its original purpose. New Artificial Intelligence (AI) techniques push the boundaries of capabilities robots can exhibit. For example, machine vision systems and, in particular, neural network (including Deep Neural Network) systems exist that provide ways to elaborate and extract actionable information from input streams in the forms, for instance, of object recognition, speech recognition, mapping (positioning of the robot in space), or ways to act upon speech and object information (e.g., by controlling motor output from robot effector/cameras/user interface/speech synthesizers).

But the programmability of conventional systems for controlling robots constitutes an issue, as they are most often seen as “black boxes” providing limited ability from the user to understand ways to harness their power for practical applications or to create usable workflows for the robot. In addition, typical/conventional robots are often programmed for specific tasks in a way that often does not scale past the original purpose. Any modifications to this programming may requires close interaction with a programmer, which can be costly and time-consuming. Other robot control solutions also take a less flexible approach to the problem at hand; for example, a shift in lighting conditions or other environmental conditions can throw off an image-recognition system that is treated like a black box.

### SUMMARY

The apparatuses, methods, and systems described herein include a new robot/platform agnostic graphical user interface and underlying software engine to allow users to create autonomous behaviors in robots and robot workflow regardless of the robot's underlying hardware and/or software/operating system. The methods are based on a stimulus-response paradigm, where multiple stimuli, e.g., input from robot sensors and/or a change in a robot's state, such as but not limited to detection of a certain color or a face/object in the robot camera input image, the internal clock of the robot processor—e.g., an iPhone or Android phone—reaching a given time of the day, the movement of the phone as sampled by the robot accelerometer and gyro, the robot's position—e.g., being within particular range of a given GPS coordinate, or on a location of the robot internal map, and/or similar inputs —, can trigger a response,—e.g., an alert to the user, a pre-recorded set of movements, navigation towards a location in the robot internal map, a reaching/grasping of the robot, a synthetic speech output, and/or other actions by the robot. A special case of stimuli/responses is represented by those applications where artificial intelligence (AI) and machine vision algorithms (e.g., algorithms commonly available in software packages such as OpenCV—Open Computer Vision), such as but not limited to artificial neural networks (ANN) and their subclass Deep Neural Networks (DNN) are used to provide stimuli (e.g., visual/auditory/other sensory objects identification and classification, speech classification, spatial learning) and responses (e.g., reaching/grasping/navigation).

In certain applications, a system may be comprised of several specialized systems or networks, each dedicated to a specific aspects of perception/robot control, or can be constituted by an integrated system, namely one system/network. An example network can include the following hardware and devices, each potentially hosting a processor or group of processors: a robot, a controller (e.g., a tablet or cell phone), a local server, a cloud server, or a combination of the aforementioned possibilities. While implementations below discuss using the apparatuses, methods and systems described herein with mobile robots, such as domestic, service, and industrial robots, military robots, drones, toy robots, and the like, it should be appreciated that any device capable of observing external and/or internal phenomenon may utilize the graphic user interface and software engine described herein. For example, heating/ventilation/air conditioning (HVAC) devices, security and surveillance systems, appliances, displays, mobile devices such as smart phones and smart watches, and/or like devices may also utilize the apparatuses, methods, and systems described herein.

Embodiments of the present technology also include a graphical user interface, as embodied in a suitable computing device (e.g., a computer, tablet, or smartphone), where the user can define, select, edit, and save stimuli and responses. Coherent groups of stimuli/responses may be grouped in “behaviors”. In some implementations, the user may utilize drag-and-drop interface for creating a behavior. The design may be similar in appearance to that of a biological neuron, which has a tripartite organization (the neuron body, the dendrites—where most inputs arrive—and the axon, which is the output channel of the neuron). In this interpretation, dendrites are stimuli, the axon contains responses, and the cell body represents a behavior, which is the collection of stimuli and responses, but other schemes are possible.

Additional embodiments of the present technology include a method for generating a hardware-agnostic behavior of at least one electronic device, such as a robot. In one example, this method comprises receiving, from a user via a user interface executing on a computer, tablet, smartphone, etc., at least one stimulus selection corresponding to at least one stimulus detectable by the electronic device. The user interface also receives, from the user, at least one hardware-agnostic response selection that corresponds to at least one action to be performed by the electronic device in response to the stimulus. A processor coupled to the user interface generates the hardware-agnostic behavior based on the stimulus selection and the hardware-agnostic response selection.

The stimulus may come from any suitable source, including a neural network. For instance, the stimulus may comprise sensing: depressing a button; swiping a touchscreen; a change in attitude with a gyroscope; acceleration with an accelerometer; a change in battery charge; a wireless signal strength; a time of day; a date; passage of a predetermined time period; magnetic field strength; electric field strength; stress; strain; position; altitude; speed; velocity; angular velocity; trajectory; a face, object, and/or scene with an imaging detector; motion; touch; and sound and/or speech with a microphone.

Similarly, the response can be based at least in part on an output from a neural network, such as a visual object (e.g., a face) or an auditory object (e.g., a speech command) recognized by the neural network. The hardware-agnostic response selection may comprise a sequence of actions to be performed by the electronic device in response to one or more corresponding stimuli.

In some cases, this method may also include receiving, via the user interface, a selection of a particular electronic device (robot) to associate with the hardware-agnostic behavior. In response, the processor or another device may associate the hardware-agnostic behavior with the particular electronic device. The association process may involve determining identifying information for the particular electronic device, including information about at least one sensor and/or at least one actuator associated with the particular electronic device. And the processor or other device may translate the hardware-agnostic behavior into hardware-specific instructions based at least in part on this identifying information and provide the hardware-specific instructions to the particular electronic device, e.g., via a wireless communication channel (antenna).

If appropriate/desired, the processor may generate at least one other hardware-agnostic behavior based on at least one other stimulus selection and at least one other hardware-agnostic response selection. Possibly in response to user input, the processor may form a hardware-agnostic personality based at least on the hardware-agnostic robot behavior and at least one other hardware-agnostic robot behavior.

In another embodiment, the present technology comprises a system for generating a hardware-agnostic behavior of at least one electronic device (robot). Such a system may comprise a user interface, a processor operably coupled to the user interface, and a communications port (e.g., a wireless transceiver or wired communications port) operably coupled to the processor. In operation, the user interface receives, from a user, (i) at least one stimulus selection corresponding to at least one stimulus detectable by the electronic device and (ii) at least one hardware-agnostic response selection corresponding to at least one action to be performed by the electronic device in response to the stimulus. The processor generates the hardware-agnostic behavior based on the stimulus selection and the hardware-agnostic response selection. And the communications port provides the hardware-agnostic behavior to the electronic device.

The system may also include a hardware translation component (e.g., an Application Program Interface (API)) that is operably coupled to the communications port and/or to the processor. In operation, the hardware translation component translates the hardware-agnostic behavior into a set of hardware-specific input triggers to be sensed by the electronic device and a set of hardware-specific actions in response to the set of hardware-specific input triggers to be performed by the electronic device.

Yet another embodiment of the present technology comprises a computer-implemented method for loading at least one hardware-agnostic behavior between a first robot and a second robot. One example of this method comprises: receiving a request (e.g., via a user interface) to load a first hardware-agnostic behavior onto the first robot; retrieving the first hardware-agnostic behavior from at least one storage device, where the first hardware-agnostic behavior defines at least one first hardware-agnostic robot response to at least one first hardware-agnostic robot sensor stimulus; providing the first hardware-agnostic behavior to the first robot (e.g., via a wireless connection); providing the first hardware-agnostic behavior to the second robot (e.g., via the wireless connection); receiving a request to load a second hardware-agnostic behavior onto the first robot (e.g., via the user interface), where the second hardware-agnostic behavior defines at least one second hardware-agnostic robot response to at least one second hardware-agnostic robot sensor stimulus; retrieving the second hardware-agnostic behavior from the at least one storage device; and providing the second hardware-agnostic behavior to the first robot (e.g., via the wireless connection). For example, in providing the second hardware-agnostic behavior to the first robot, the first hardware-agnostic behavior may be replaced with the second hardware-agnostic behavior. In some cases, this method may also include providing the second hardware-agnostic behavior to the second robot.

Still another embodiment of the present technology comprises a computer-implemented method for generating behaviors for a robot. An example of this method comprises receiving, at a user interface, a selection of at least one stimulus to be sensed by the robot and a selection of at least one response to be performed by the robot, e.g., in response to the selected stimulus. One or more processors operably coupled to the user interface generates a behavior for the robot based at least in part on the stimulus and the response and renders, via the user interface, the behavior as a behavior neuron. This behavior neuron may appear as a dendrite that represents the stimulus and at least part of a neuron axon (e.g., a myelin sheath section of the axon) representing the response. In some cases, the behavior neuron may be rendered as one neuron in a plurality of neurons in a graphical representation of a brain. For instance, the graphical representation of the brain may show the neuron based on the nature of the behavior in relation to behavior centers of an animal brain.

And another embodiment of the present technology comprises a method of engaging at least one hardware-agnostic behavior to control at least one robot. The hardware-agnostic behavior comprises at least one action to be performed by the robot in response to the stimulus sensed by the robot. In at least one example, this method comprises establishing a communications connection between the robot and a graphical user interface (GUI). The GUI receives an indication from a user regarding selection of the hardware-agnostic behavior. A processor or other suitable device coupled to the GUI retrieves, from a memory operably coupled to the control device, instructions for causing the robot to operate according to the hardware-agnostic behavior. The processor executes the instructions so as to engage the hardware-agnostic behavior to control the robot.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIG. 1 shows a schematic block diagram of a system for defining and executing a Hardware-Agnostic Brain System for Autonomous Robots.

FIG. 2 is an illustration of possible connectivity schemes between controlling device where the user interface runs, the robot, and other intermediates connectivity steps, including relationship with cloud computing devices.

FIG. 3A illustrates an example implementation of a Behavior (shown as circle) as a collection of Stimuli (squares) and Responses (triangles).

FIG. 3B depicts a biological neuron, which has a structure analogous to the behavior implementation shown in FIG. 3A.

FIG. 4A shows a schematic representation of the collection of Behaviors as Brain.

FIG. 4B shows a schematic representation of different Brains as having different sets of Behaviors.

FIG. 5A illustrates variations in Brains, with each Brain comprising its unique constituent Behaviors (circles), and each Behavior comprising a unique set of Stimuli (squares) and Responses (triangles).

FIG. 5B illustrates how an output (response) from one behavior (neuron) can be used as a stimulus for another behavior.

FIG. 6 shows an example of a drone with 2 Behaviors: Behavior 1 (1 stimulus, 1 response) and Behavior 2 (2 stimuli, 2 responses).

FIG. 7 shows a welcome screen for an exemplary Graphical User Interface (GUI) for defining a hardware-agnostic brain and controlling a robot using a hardware/robot-agnostic interface.

FIGS. 8A and 8B show a robot selection screen in the GUI of FIG. 7.

FIGS. 9A and 9B show various exemplary GUI screens to select, add, delete, and save customized Brains using the GUI of FIG. 7.

FIGS. 10A-10C show various exemplary GUI screens to edit and configure customized Brains using the GUI of FIG. 7.

FIGS. 11A-11E show various exemplary GUI screens to configure and save customized Behaviors by choosing, adding, deleting various Stimuli and Responses using the GUI of FIG. 7.

FIGS. 12A-12D show various exemplary GUI screens with operational views of controlling a robot with a hardware-agnostic brain.

FIG. 13 shows an exemplary GUI of a Robot Knowledge Center that the User can use to label knowledge learned or collected by the robot's sensor network.

FIG. 14 shows an exemplary embodiment of a construction process of a generalized Application Program Interface (API) for defining and implementing a hardware-agnostic brain.

FIG. 15A describes an exemplary reactionary process flow of a Robot configured with a Hardware-Agnostic Brain with “n” number of Behaviors.

FIG. 15B is a flow diagram that illustrates a scheduling process executed by the in FIG. 15A.

### DETAILED DESCRIPTION

Robots are typically programmed to perform specific functions using a programming language, typically to execute repetitive tasks or to be operated remotely by a user. For many robots, each mode of operation and/or interface is specific for a particular type of robot or robot operating system. Many commercially available autonomous robots of various types or forms are pre-programmed in the programming language of manufacturer's choosing. Deploying a plurality of dissimilar robots in a centralized fashion by a single user would thus require learning and utilizing many of robots' hardware-specific “native” programming languages. This makes it impractical for a user with limited time and/or programming experience to program and use more than one type of robot because the user would have to configure each type of robot individually. In other words, a user would need to craft one specific set of actionable instructions for one type of robot, for example, for general crop surveillance, another instruction set for another type of robot, for example, for close-up spotting of irrigation and/or pest problems, and another instruction set for another type of robot, for example, to spray pesticides to the affected regions of the crop.

Benefits and advantages of the present technology include, but are not limited to simplicity of use, no need for technical expertise, and scalability. By way of simplicity of use, rather than thinking in terms of sensor readings, thresholds, and continually running algorithms, the user can design robot workflow based on discrete stimuli and responses to stimuli (e.g., when the robot senses something, it performs a particular action). In addition, the present technology does not require programming lines because it supports work done through a Graphic User Interface (GUI), making it accessible to non-technical users. And solutions scale from one robot to another and can use the same interface.

Platforms for Defining and Implementing Hardware-Agnostic Brains

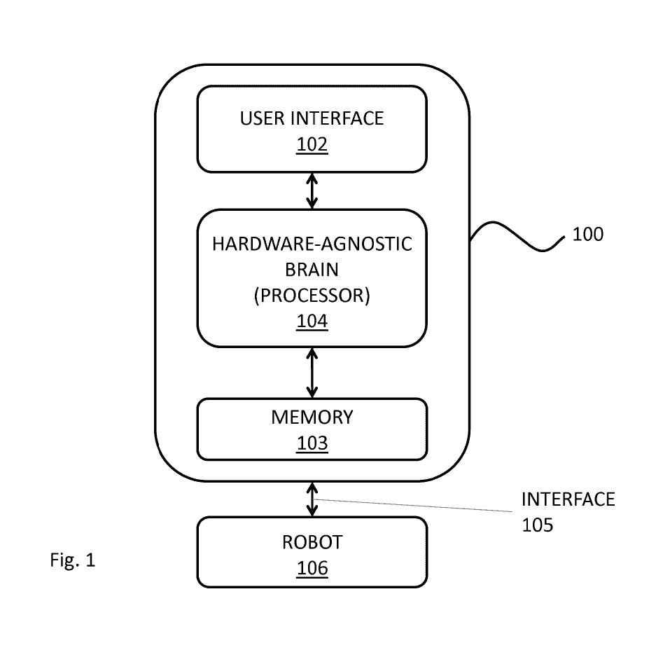

FIG. 1 illustrates a platform 100 that can be used to define and implement a hardware-agnostic brain for controlling almost any robot 106. The platform 100 addresses the fragmentation problem with platform and hardware-specific programming languages identified above. It also provides an intuitive, easy-to-use interface for programming robots. And it allows a user to port and apply a preprogrammed behavior or set of behaviors among many robots, including dissimilar robots.

The platform 100 includes a user interface 102 that enables a user to define a hardware-agnostic brain, a processor 104 that implements the hardware-agnostic brain (which may include processes and programs implementing Artificial Intelligence (AI)/Artificial Neural Network (ANN)/Deep Neural Network (DNN) processing), a memory 103 to store instructions for defining and executing the hardware-agnostic brain (including instructions implementing AI/ANN/DNN and synaptic weights defining ANN/DNN structures), and a communications interface 105 for communicating with the robot 106. The user interface 102 allows the user to create actionable tasks and/or usable workflows for the robot 106. The platform 100 interprets and implements these workflows as a hardware-agnostic brain 104 that interprets data from the robot 106 and input entered via the user interface 102, then performs one or more corresponding actions. The platform 100 can be implemented in any suitable computing device, including but not limited to a tablet computer (e.g., an iPad), a smartphone, a single-board computer, a desktop computer, a laptop, either local or in the cloud, etc. The platform 100 may provide the user interface 102 as a Graphical User Interface (GUI) via a touchscreen or other suitable display.

The user interface 102 includes a single GUI to run an underlying Application Programming Interface (API) for interfacing with a hardware-agnostic brain 104 and for communicating with and controlling the robot 106. The GUI for the user interface 102, for example, may include any shape or form of graphical or text-based programmable keys or buttons to input instructions and commands to configure the brain 104 via a touchscreen of an iPad, an Android tablet, or any suitable computing device with interactive input capabilities. A user, such as a non-technical farmer, can communicate and/or control any type, form or number of robots 106 by pre-programming the brain 104 using the simple user interface 102.

Brain 104 can be hardware-agnostic in that it can be programmed by a user with limited time and/or programming experience to control and configure any robot 106 via a user interface 102. Hardware-agnostic brain 104 can be one, or a combination, of modern AI systems, machine vision systems, and/or in particular, neural networks (including ANNs and DNNs) systems that can provide a more complex way to elaborate and extract actionable information from input streams in the forms of, for instance, object recognition, speech recognition, mapping (positioning of the robot in space) and/or ways to act upon that information (e.g., by ways of controlling motor output from robot effector/cameras/user interface/speech synthesizers). For example, the user can create a single or combination of hardware-agnostic brain or brains 104 to configure and control any type, form, or number of robots 106.

The memory 103 serves as a storage repository and/or conduit of inputs and instructions, library and/or knowledge database (including synaptic weights of an ANN/DNN) between the user interface 102 and the hardware-agnostic brain 104. For example, one or more inputs or instructions from the user interface 102 can be stored for a specific time or duration inside the memory 103. Input information stored inside the memory 103 can also be processed and/or released to the hardware-agnostic brain 104 at a prescribed time and/or for prescribed duration. The memory 103 can also receive the input data or information from the hardware-agnostic brain 104 or from the robot 106, via the interface 105, to be stored for further processing.

The platform 100 communicates with the robot 106 via the communications interface 105, which can be a wired or, more typically, wireless interface. For instance, the interface 105 may provide a WiFi, Bluetooth, or cellular data connection to the robot 106 for sending commands and queries from the processor 104 and for relaying sensor data and query replies from the robot 106 to the processor 104. The interface 105 may also communicate with other devices, including sensors that relay information about the robot 106 or the robot's environment and computing devices, such as tablets or smartphones, that host some or all of the user interface 102. The interface 105 may also communicate with a server or other computer that implements part or all of the processing for the hardware-agnostic brain.

Robot 106 can be any robot or a plurality of robots, including but not limited to wheeled robots that travel on land, walking robots that walk on any number of legs, robots that can jump or bounce, and drones, such as, for example unmanned aerial vehicles (UAVs) and unmanned underwater vehicles (UUVs). Any type, form or number of robot 106 can be programmed with hardware-agnostic brains 104 via a user interface 102 to create a universal programming platform 100 that can offer a user with limited time and/or programming experience to maximize utilization of various functionalities unique to any type, form or number of robots 106.

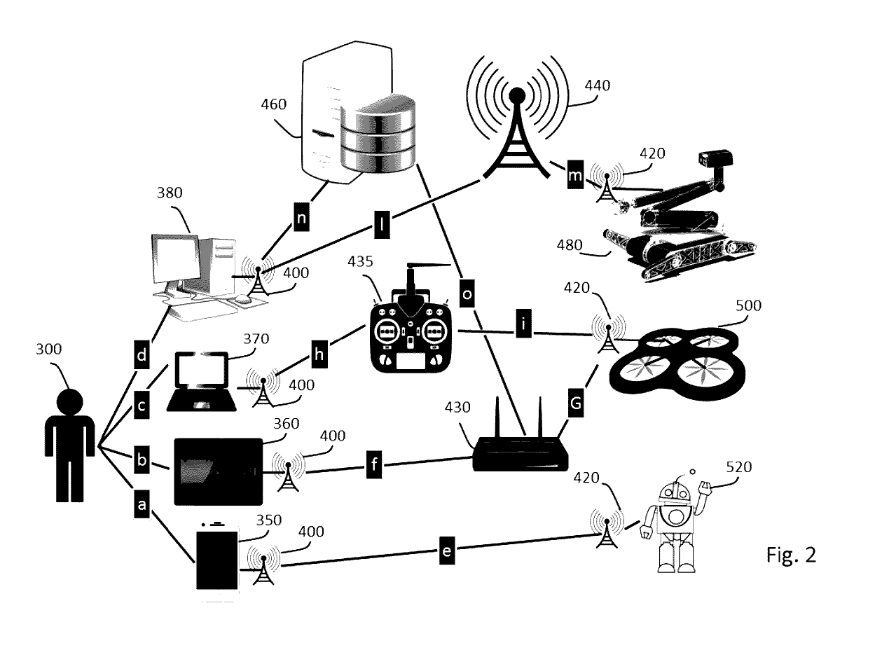

FIG. 2 illustrates a plurality of possible real-world scenarios of how a hardware-agnostic brain 104 can be utilized. Via a simple GUI, a user 300 can implement a hardware-agnostic brain that controls and manipulates various functions of any robot via an API without having to know and/or work in the robot's native programming language. The nature of such hardware-agnosticism of the brain can also enable controlling of and communicating with any robot independently of the program platform of the host electronics devices, communication methods, or connectivity options.

A hardware-agnostic brain can be implemented on a number of ubiquitous everyday computing devices, including but not limited to a smart phone 350, a tablet 360, a laptop computer 370, a desktop computer 380, or a server 460 via several connectivity options 400 (e.g., Wi-Fi, Bluetooth, 3G, 4G, and the like). In some cases, one or more servers 460 may process instructions and data received via a GUI provided via one or more smartphones 350 or tablets 360 and one or more robots.

By programming via the GUI of the hardware-agnostic brain on a suitable computing device, a user 300 can control one or more robots, such as a wheeled surveillance robot 480, a drone 500, and a walking toy robot 520. Some additional interaction schemes between the user and a particular robot may include longer range intermediate connectivity options that can provide wireless connections between the user 300, a robot, and any form of wireless communication nodes and platforms, such as a Wi-Fi router 430 and a cellular network tower 440, for interfacing or interconnecting with a cloud computing server or device 460.

For example, if the user 300 is employing a smart phone 350 (a) to host a user interface, the phone 350 can use one of several wireless connectivity methods 400 (e.g., Wi-Fi, Bluetooth, 3G, 4G, and the like) to connect via a wireless signal (e) to a receiver 420 in, for instance, a toy robot 520. In another example, the user 300 can employ a tablet (e.g., an iPad) 360 (b) to host a user interface. The tablet 360 can use one of several wireless connectivity methods 400 (e.g., Wi-Fi, Bluetooth, 3G, 4G, and the like) to connect via a wireless signal (f) to a Wi-Fi router 430, which in turn can be connected to a receiver 420 in, for instance, a drone 500. In another example, the user 300 can employ a laptop computer 370 (c) to host a user interface. The laptop computer 370 can use one of several wireless connectivity methods 400 (e.g., Wi-Fi, Bluetooth, 3G, 4G, and the like) to connect via a RC device 435 (h) in turn connected to a receiver 420 (i) in, for instance, a drone 500.

In another example, a user 300 can employ a desktop computer 380 (d) to host a user interface. The desktop computer 380 can use one of several wireless connectivity methods 400 (e.g., Wi-Fi, Bluetooth, 3G, 4G, and the like) to connect via a wireless signal (l) to a cellular network tower 440, which in turn can be connected to a receiver 420 (m) in, for instance, a wheeled surveillance robot 480. The desktop computer 380 (d) can also use one of several wireless connectivity methods 400 (e.g., Wi-Fi, Bluetooth, 3G, 4G, and the like) to connect via a wireless signal (n) to a computing (e.g., cloud) server 460, which in turn can be connected to a Wi-Fi router 430 (o), which in turn can be connected to a receiver 420 (g) in, for instance, a drone 500.

Hardware-Agnostic Robot Brains, Behaviors, Stimuli, and Responses

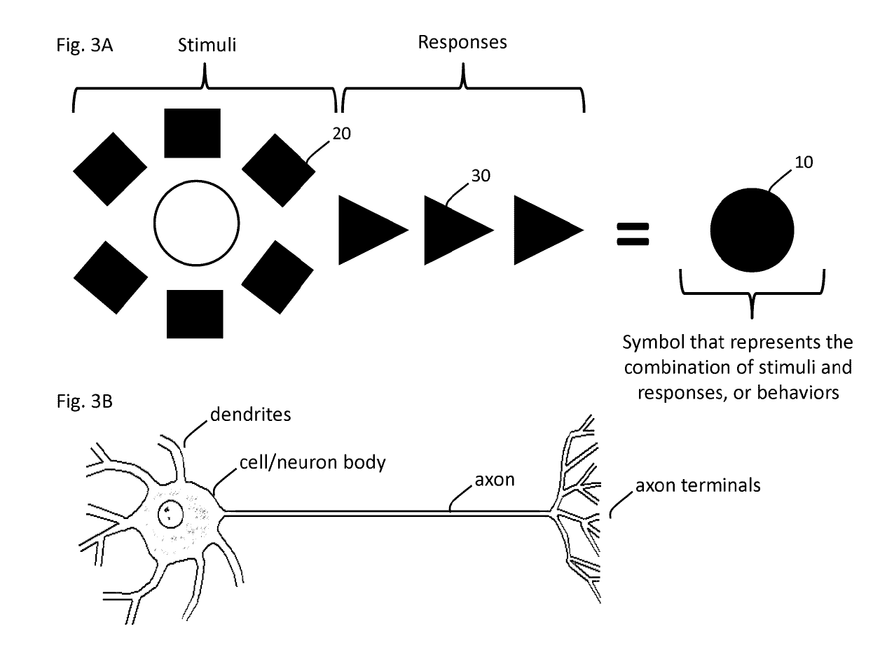

FIGS. 3A-6 illustrate fundamental building blocks for defining hardware-agnostic robot brains. As described in greater detail below, each brain comprises one or more behaviors. Each behavior, in turn, comprises one or more stimuli and one or more responses. The stimuli may represent changes in environmental parameters that the robot can detect with on-board or networked sensors; the status of the robot's internal and external components; and commands and signals received from other sources. The responses represent actions that the robot can take. Together, the stimuli and actions that make up a particular behavior specify how the robot works and functions.

FIG. 3A shows an example implementation of a behavior 10 in which stimuli 20 are represented as squares, responses 30 as triangles, and behaviors 10 (collections of stimuli and responses) are represented as circles. The representations in FIG. 3A mimic the structure of a biological neuron, which includes a cell body, dendrites, and an axon that splits into axon terminals as shown in FIG. 3B. The axon splits into multiple axon terminals. Other representations of behaviors 10, stimuli 20, and responses 30 are also possible.

As shown in FIG. 3A, a behavior 10 may comprise at least one stimulus 20 and at least one response 30, but can comprise a plurality of stimuli 10 and a plurality of responses 30. In some implementations, a behavior 10 may comprise a set of external responses 20 (e.g., movement of the robot via activating a motor) and/or internal responses 20 (e.g., change in the state of the robot which is not manifested externally to a human user) triggered by one or more external stimuli 30 (e.g., visual or auditory stimuli as detected by appropriate sensors, and/or elaborated by dedicated or integrated artificial intelligence (AI) systems, e.g. neural networks for perception, planning, and navigation) or internal stimuli 30 (e.g., a clock reaching a particular time, a counter reaching a particular count, the robot entering a particular state—e.g., low battery, detection of an object in the robot camera, location of the robot in a particular location of its internal map, etc.). To trigger a response 30 in a behavior 10, all stimuli 20 may have to occur simultaneously (logical AND statement) or in a particular sequence, and when their conditions are all achieved, all responses 30 may be executed sequentially as arranged by the user (FIG. 3A).

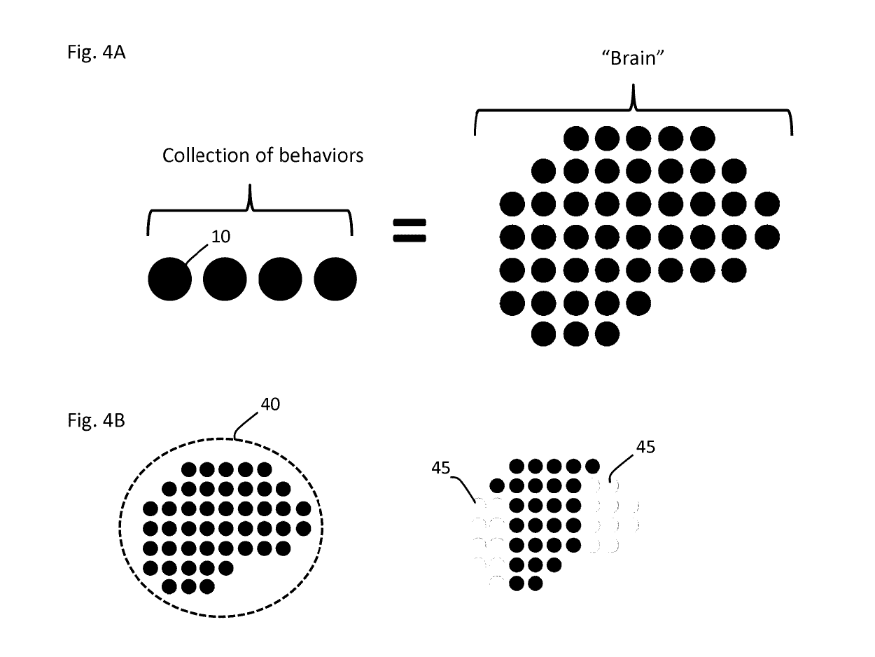

FIGS. 4A and 4B show that a collection of behaviors 10 so defined constitutes a “brain” 40 A brain and its constituent behaviors 10 can be implemented in any suitable manner, including as a deep neural network running locally on a computer, tablet, or smartphone or remotely on a server. The brain may be stored locally on the electronic device used to define the brain, on a robot, and/or in a cloud-based storage system (a server). In some implementations the cloud computing and storage system may provide the brain to the robot; in other implementations the electronic device (e.g., mobile phone, tablet, a single-board computer on board of the robot, and/or the like) may provide the brain to the robot. In another implementation, a combination of local (on the robot), controller (e.g., a user cell phone, tablet, laptop, or desktop), and cloud (e.g., a remote server) jointly provide computing power for the brain.

In some implementations, a robot brain may also include one or more robot personalities 45, each of which may comprise one or more behaviors (e.g., a brain may include a personality comprising four behaviors, and/or the like) as shown in FIG. 4B. For example, a subset of the collection of behaviors (e.g., a subset attributed to certain types of stimuli, certain types of responses, and/or the like) may be associated with each other, forming a personality component of the brain. A brain may comprise a plurality of personality and behavior components. Personality components may allow for a faster and more streamlined process of adding and/or removing sets of behaviors in a robot brain, and/or the like, and could be used to build “brains” out of “personalities”. Examples of personalities include, but are not limited to: (1) a “friendly” personality, composed of the following two behaviors: =dance when a person is seen; =ask “hello, what is your name” when a person is seen; and (2) a “suspicious” personality, composed of the following three behaviors: =take a picture when a person is seen; =say “who is there” when a person is seen; =follow a person which enters the camera focus.

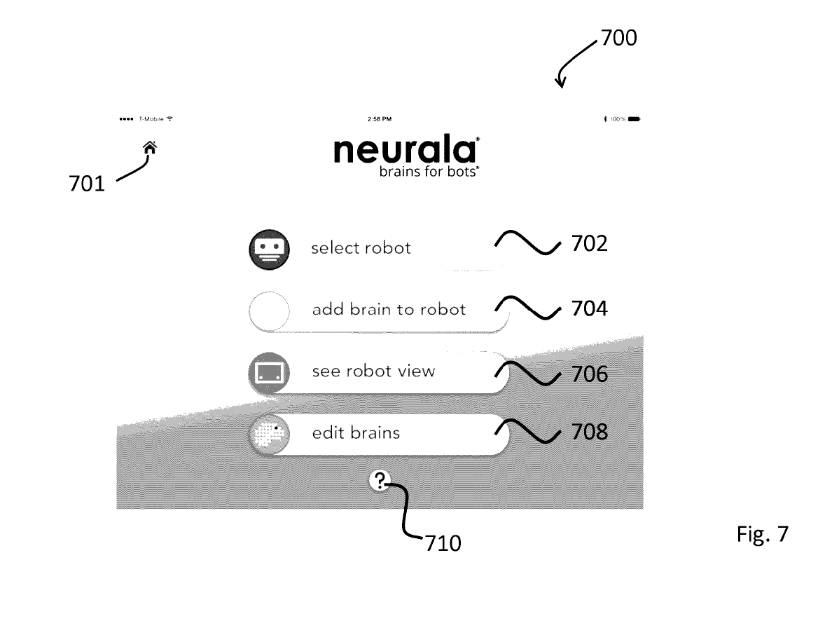

In some implementations, the robot brain may be independent from the robot's model or operating system. For example, the brain may convert a response instructing the robot to move diagonally 2 feet after seeing a person into appropriate motor commands for different robots. In some cases, the brain may convert the movement instructions into an instruction to roll forward and then turn to reach a destination for a ground-based robot using an Application Program Interface (API) provided by the robot manufacturer as described in greater detail below with respect to FIG. 7. But for a flying robot, the brain may convert the movement instruction into a set of instructions: take off, fly diagonally 2 feet, and then land, again using the API calls provided by the robot manufacturer.

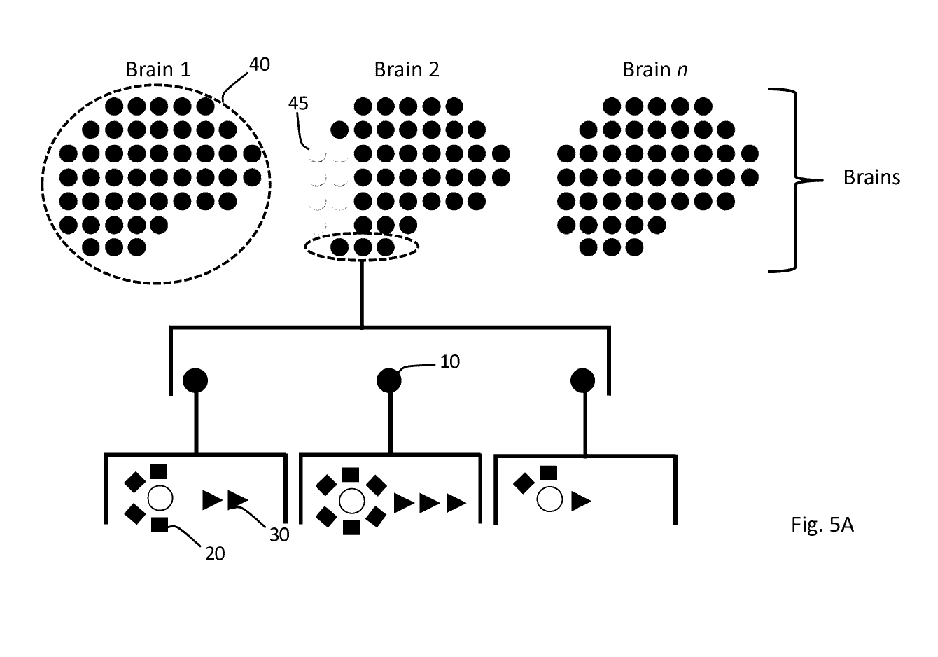

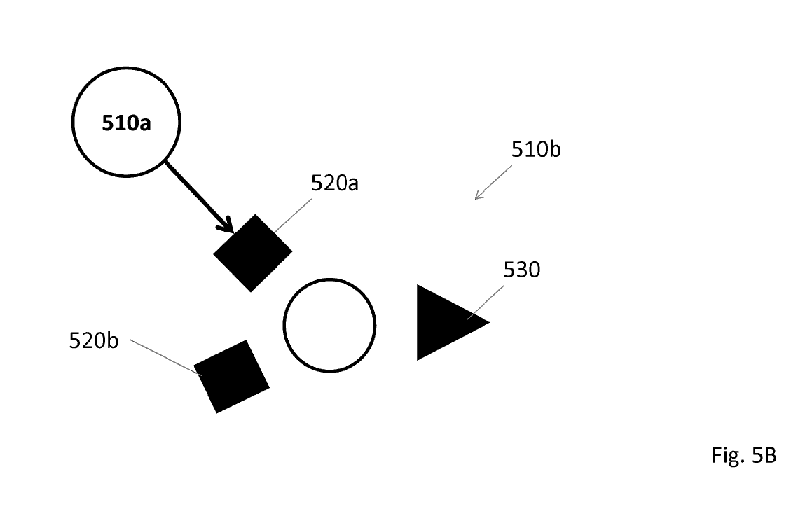

FIG. 5A shows that a robot brain may comprise a hierarchy of brain components. As in FIG. 4, each behavior 10 component in FIG. 5A may comprise a set of stimuli-response components. In FIG. 5A, each stimulus in the set of stimuli is represented as a square (20); each response in the set of sequential responses is a triangle (30). Each behavior component (represented as a circle) can comprise a different number of stimuli and/or responses in the stimuli-response set.

FIG. 5A also shows that the behaviors in a brain may be given a priority order of execution. For example, if two behaviors are activated by the sensors, a priority may be assigned to the one behavior over the other behavior, e.g., based on the behaviors' positions in the brain representation. Priority behaviors may be allowed to complete a sequence of responses or not, depending on the implementation, before other behaviors are executed. Behaviors of lower priority may be interrupted before they complete execution if a higher priority behavior is activated. In other implementations, the last response in a chain of responses needs to be completed for other behaviors to be engaged.

FIG. 5B shows an example of how behaviors (neurons) in a brain can be connected to each other or “chained together.” In this case, a first behavior 510a produces a particular output (e.g., motion in a particular direction or to particular GPS coordinates) that serves as a stimulus 520a for a second behavior 510b. If the second behavior's other stimulus 520b (e.g., recognition of a particular object in imagery acquired by a camera) is present, then the second behavior 510b produces its own response 530, which in turn may stimulate another behavior. Thus, triggering of the first behavior 510a is a stimulus for a second behavior Slob.

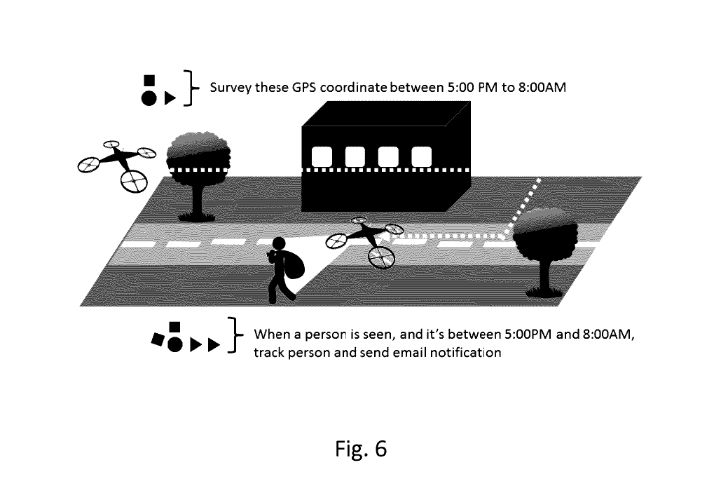

Additionally, behaviors can be “chained”, namely, they can be organized in sequences where the stimulus for a given behavior can be represented by the completion or termination of another behavior. For example, FIG. 6 illustrates chained behaviors that are executed by a drone (UAV) to monitor a particular area

1=track when you see a new person
▪=an unknown person is seen by the camera
▪=it is between 5:00 PM and 8:00 AM [symbol]
=engage tracker centered around a person; [symbol]
=send an email notification.
2=survey particular Global Positioning System (GPS) coordinates at a specified time
▪=1 is terminated (tracking has suspended, e.g., the person is out of sight)
▪=it is between 5:00 PM and 8:00 AM [symbol]
=survey GPS coordinates

In some implementations, a stimulus can be determined by the user performing an action on the controller. For instance, a user may select an object shown on a touchscreen or other device that displays imagery from an image sensor mounted on the robot. This selection may trigger a response by the robot brain in the form of a machine vision/AI/ANN/DNN visual learning and tracking algorithm that tracks the selected object/person.

In some implementations, even though each stimulus and response is independent of hardware on any particular robot useable via the interface, certain stimuli may not be observable by a particular robot, and/or certain responses may not be performable by a particular robot, rendering a behavior difficult and/or impossible to act upon for a particular robot. In such instances, the robot may ignore the behavior until its capabilities have changed, the user may be prompted to change the behavior when selecting a robot to use the behavior and/or a brain with the behavior, and/or the like.

Additionally, the computing medium where behaviors and their collections may be implemented may be a processor on board of the robot, the robot controller (e.g., a laptop, a tablet, or a cell phone), a remote (cloud) server, or may be partially implemented in any of the above-mentioned devices, e.g., as described above with respect to FIG. 2. E.g., in certain instantiations, the computation underlying simple behaviors especially these that require time-sensitive responses may be implemented in the robot, some others in the controllers, whereas some more complex and computationally intensive behaviors that do not require short latency responses may be implemented in the cloud, namely on a remote server connected to the robot via a tethered or wireless connectivity.

Additionally, given that brains and behaviors are implemented in a robot agnostic fashion, brains can be “moved” from robot to robot, e.g., by “copying” and “pasting” them from device to device without loss of functionality except from behaviors (stimuli/responses) which are incompatible between different platforms.

Examples of Stimuli and Responses

A hardware-agnostic brain can receive one or more stimuli from one or more of the following sources including, but not limited to the user input via the GUI, a network of sensors that reside on the robot, and algorithm output itself from the AI/ANN/DNN of the hardware-agnostic brain.

Examples of the user input stimuli include, but not limited to physical inputs, such as, for example a touch button press on the Control screen of an icon (e.g., a brain) of the GUI, a button press on Control screen of either the robot or the controlling unit, a finger or palm swipe on the touch screen (the user may be allowed to instruct the robot to memorize a pattern), a general reorientation motion, including tiling, rotating, turning over, touching, or any combination of manipulation, of the entire device, and a multi-digit input (e.g., a “pinch”) on a touchscreen.

Examples of stimuli from a network of sensors from the robot include, but not limited to quantitative or status readings of one or more sensors, such as for example, battery indicator, strength in quantitative nature, presence or absence of 3G or 4G signal, strength in quantitative nature, presence or absence of Wi-Fi signal, strength in quantitative nature, presence or absence of Bluetooth signal, time, date, various of functions of stopwatch capabilities, including countdown, timer, etc., quantitative nature of acceleration in various units, quantitative nature of velocity in various units, quantitative nature of angular velocity in various units, quantitative nature of speed in various units, strength in quantitative nature of and pointing direction of magnetic field, orientation of magnetic azimuth (true north), quantitative nature of Latitude readings, quantitative nature of Longitude readings, quantitative nature of altitude readings, and course.

Some other examples of stimuli from the robot are of visual nature (e.g. visual stimuli) and can include, but not limited to color detection, face detection, face recognition, object recognition, scene recognition, and gesture recognition.

Some other examples of stimuli from the robot are of audio nature (e.g. audio stimuli) and can include, but not limited to any loud sound, speech recognition, speaker recognition, musical or note patterns, and pre-defined auto cue (e.g., clapping of hands).

Some other examples of stimuli from the robot are of geographical nature (e.g. location stimuli) and can include, but not limited to location provided by GPS coordinate, location provided by internal map generated by the robot (e.g., SLAM maps), location provided by map supplied by the user, visual scene recognition (e.g., “this looks like the kitchen”), and auditory scene recognition (e.g., “this sounds like the kitchen”).

Examples of stimuli that are algorithm output itself from the AI/ANN/DNN of the hardware-agnostic brain (e.g. algorithmically defined stimuli) can be any stimulus that is generated by the output of a machine vision (e.g., OpenCV), AI, ANN, or DNN algorithm that elaborates physical or any other stimuli input to the system

A hardware-agnostic brain can output one or more responses including, but are not limited to tracking an object/person identified by the algorithm (stimulus=detection of object/person) or by the user (stimulus=a “pinch” on the object in an iPad screen), executing user recorded actions, meaning anything that the robot can do is memorized, making a sound or another non-motion item, taking a picture, recording audio or video, executing intelligent motion, such as find a person or go to a location, posting picture/video on a social media, updating a database, sending an email notification, and engaging, launching, and/or communicating with another software application.

GUIs for Adding and Modifying Hardware-Agnostic Robot Brains

FIGS. 7-12D illustrate an exemplary GUI for creating, editing, and selecting a robot brain and for controlling a robot, either directly or with the brain. As explained below, the GUI may be organized into Connect, Control and Configure components with a navigation page.

FIG. 7 illustrates a navigation page 700 that shows four buttons, each with a unique icon, for connecting to a robot, configuring a robot bran, and controlling a robot. The buttons include “select robot” button 702 to select and connect to a robot, an “add brain to robot” button 704 to select a brain for the robot, a “see robot view” button 706 to see real-time (image) data provided by the robot's sensory suite and to control the robot directly, and an “edit brains” button 708 to edit the hardware-agnostic brains available for the robots. The navigation page 700 also includes a “home” button 701 that returns the user to the navigation page 700 and an information button 710 that leads the user to information/support options. This is one of many exemplary combinations of navigation page 700 that can be used in this approach. Other approaches may also enable, for example, to access robot selection, robot operation, brain selection, and brain editing in different combinations, graphic styles, and order, but with equivalent underlying functionalities.

Selecting and Connecting to a Robot

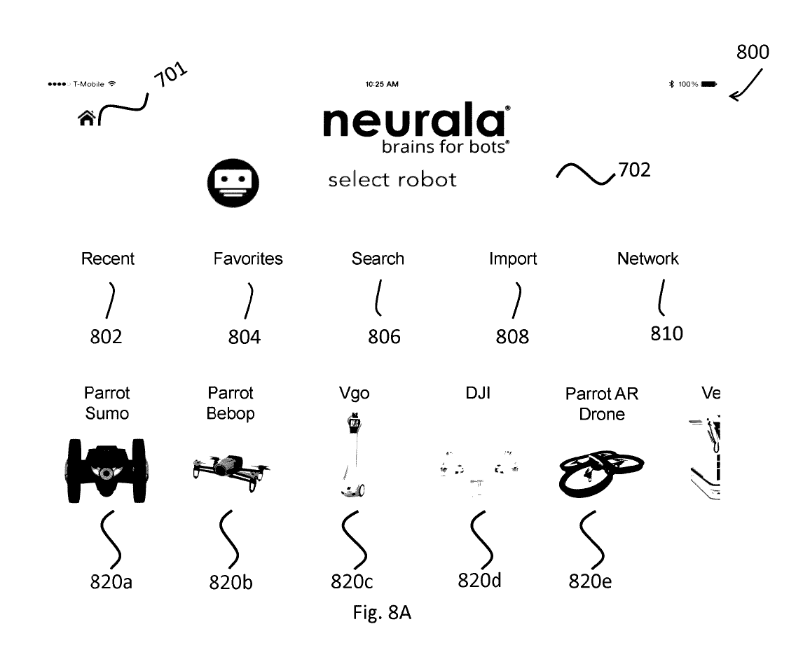

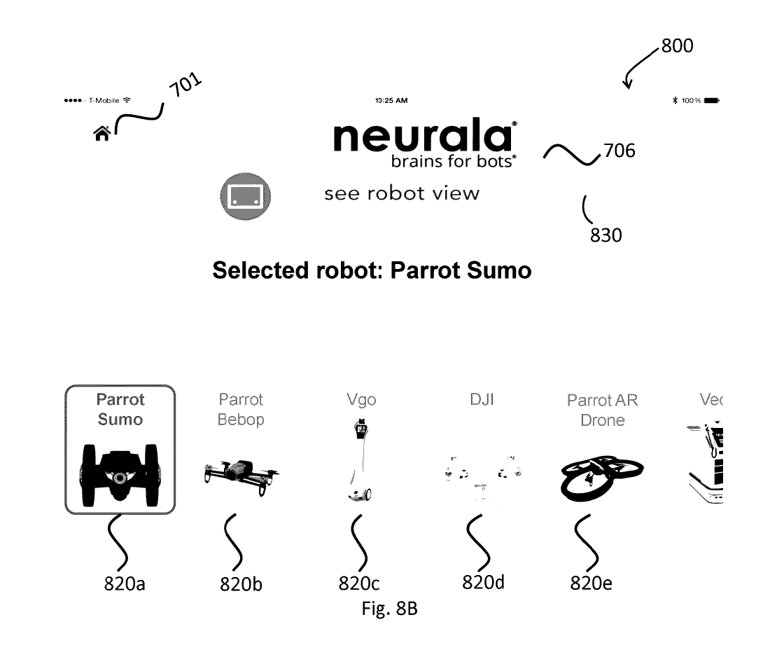

FIGS. 8A and 8B show a “select robot” screen 800 that implements the Connect component of the GUI and can be reached by selecting the “select robot” button 702 on the navigation page 700 shown in FIG. 7. The “select robot” screen 800 shows robots available for connection to the brain and options for identifying and connecting to other robots and for obtaining resources for the operation of a particular robot. The user can use this page to select and connect to a robot or swarm of robots via a wide-area network (WAN), a local-area network (LAN), or a short-range connection, such as Bluetooth or near field communication (NFC). The user may also manually input a specific IP address associated with a particular robot. Additionally, this GUI display screen can be used to connect the robot to additional computing resources or knowledge databases (e.g., additional processing resources, such as a “cloud brain”), to additional brains available in a local server, to other robots, to the Intranet/Internet (e.g., corporate directories, LinkedIn) for additional knowledge to use in brains (e.g., knowledge of faces/information about employees), and to a “brain store” (community developed brains, etc.).

In some cases, this framework allows connecting a single interface to multiple robots. (In other cases, a robot's API or protocol may allow only one robot to connect to a device at a time or to share data streams with other devices/robots.) For example, a single device may control multiple robots if the robots' API communication protocol(s) allow the robots to share streams and when the controlling device has enough processing power to handle processing on multiple data streams simultaneously (e.g., one video stream from each robot). The amount of processing to maintain and utilize a connection varies from robot to robot, so the total number of robots that can be connected to a single device depends on the device's processing power and the robots' processing requirements, among other things.

FIG. 8A shows that screen 800 enables the user to select a “recent” button 802 to show recently used robots, a “favorites” button 804 to see and modify a list of preselected favorite robots, a “search” button 806 to can enable searching for any robot, an “import” button 808 to import drivers and/or other software for controlling a particular robot, and a “network” button 810 to display a list of robots connected to a computer/communications network. Screen 800 also identifies specific robots by name and/or by type. In this case, the available robots include: a Parrot Sumo (button 820a), a Parrot Bebop (button 820b), a Vgo (button 820c), a DJI (button 820d), and a Parrot AR Drone (button 820e). Examples of robots that may be capable of interfacing with the application include, but are not limited to:
Wheeled robots;
Aerial drones and quadcopters, e.g., Parrot Bebop, Parrot AR Drone, 3D Robotics Iris, DJI Drones, Airwave autopilots;
Toy robots with cameras or that accept external cameras, e.g., Parrot Sumo, Romotive Romo, WowWee RoboSapiens;
Service/domestic/professional robots, e.g., iRobot Roomba, Vecna QC Bot, Harvest automation;
Telepresence robots, e.g., Vgo, MantaroBot TeleMe, Anybots QB, Double Robotics, Beam+, iRobot AVA, Swivl; and
Industrial robots, e.g., Kuka robots, ABB robots, Rethink Robotics robots.
   The user may also select a mode that does involve connecting to a robot, such as a “NO-BOT” mode for use with an iPhone that is not in a robot body or a “tester” mode that may allow a user to use a virtual robot in a virtual environment. Tester mode may be useful for training a new user or for a person programming a brain without a working robot. These modes enable the application to run with no wireless connectivity (e.g., the user may be able to turn on airplane mode for testing, and may either connect to a virtual robot or instruct the user to try connecting to the robot once the user has a wireless connection with the robot).

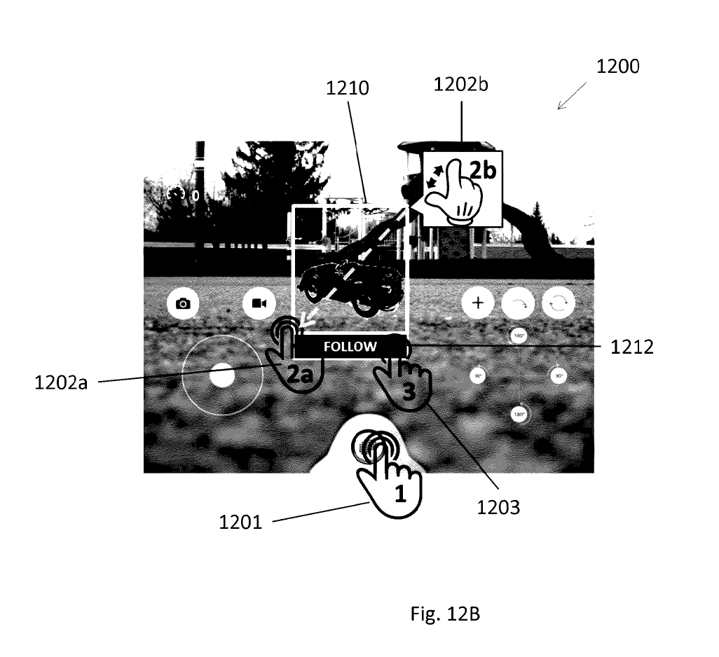

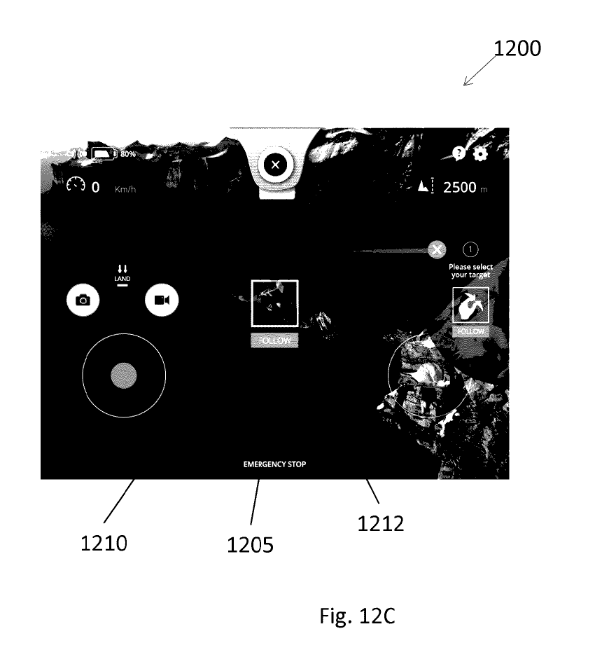

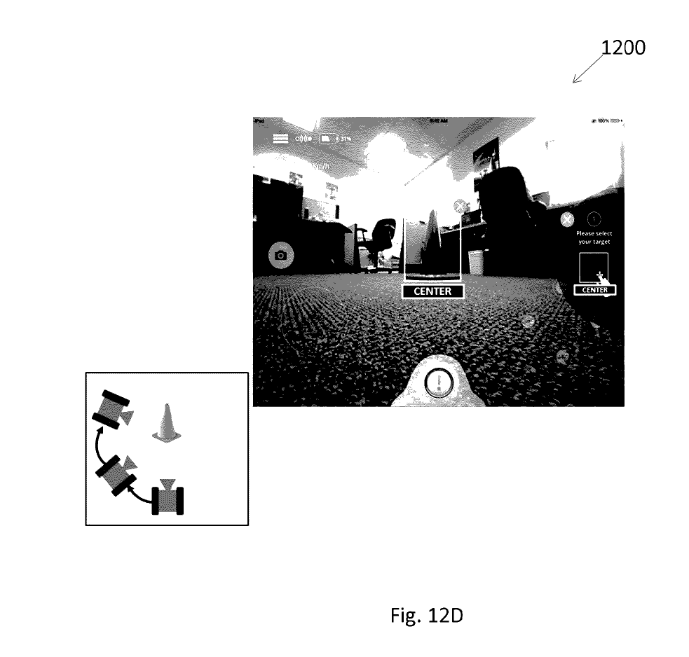

If the user selects a particular robot, such as the Parrot Sumo as in FIG. 8B, screen 800 displays the selected robot in a selection bar 830. The GUI and associated processor connect to the selected robot and provide the “see robot view” button 706, which if selected presents sensor data from the robot. Selecting the “see robot view” button 706 also enables the user to control the robot as described below with respect to FIGS. 12A-12D.

Adding a Brain to a Robot

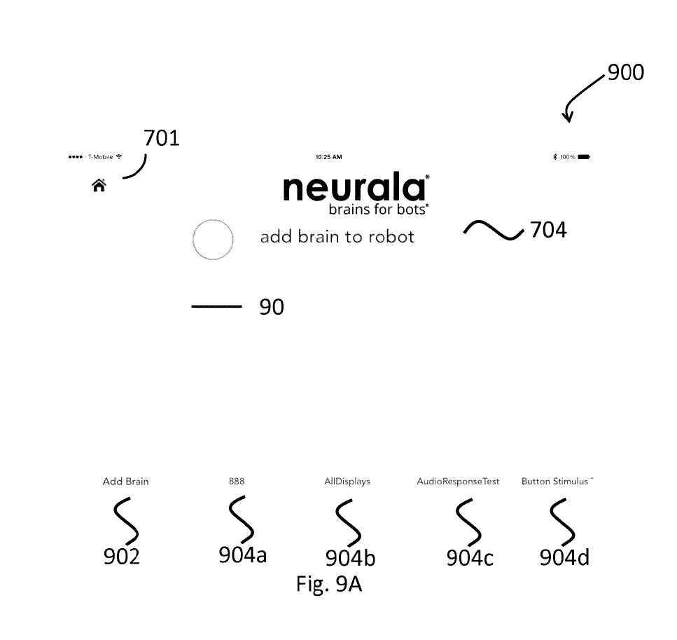

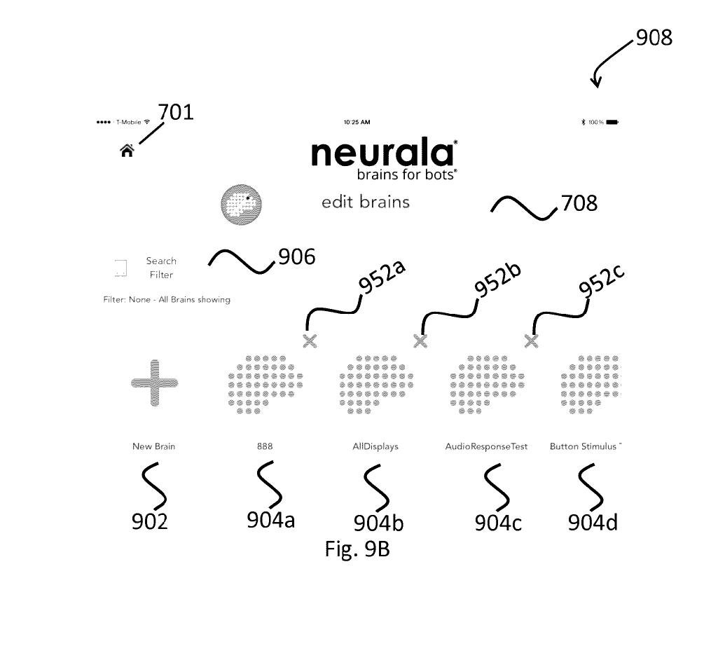

FIGS. 9A and 9B show a dedicated GUI display screen 900 that provides part of the “Configure” component. It appears if the user selects the “add brain to robot” button 704 on the navigation page 700. The screen 900 shows several icons representing various GUI functionalities including an “add brain” button 902 and buttons associated with previously defined brains, shown in FIGS. 9A and 9B as “888” brain 904a, “AllDisplays” brain 904b, “AudioResponse Test” brain 904c, and “Button Stimulus” brain 904d (collectively, previously defined brains 904). The previously defined brains 904 can be created and stored locally by the user or accessed or downloaded via a cloud resource, such as a “brain store” or a free sharing framework. Screen 900 also includes a search input 906 that enables to the user to search for a particular brain and/or filter brains by name, robot type, or other brain characteristic. Brains can be “swapped” via a GUI on the iOS device as described below.

Each brain (including each previously defined brain 904) may have an xml representation that can be shared across one or more devices (robots) simultaneously, sequentially, or both simultaneously and sequentially. For instance, a particular brain can be swapped among robots and/or transmitted to multiple robots via a GUI executing on a iOS device, Android device, or other suitable computing device.

The user can apply one brain to many robots, one brain to many different types of robots, and/or many brains to one robot via screen 900 without having to know or understand the specifics of the brain commands, the robots' capabilities, or how to program the robots. If the user selects a brain that is incompatible with the selected robot, the GUI may present a message warning of the incompatibilities. For example, if the selected robot is a ground robot and the brain includes a behavior for a UAV, such as a “Fly Up” command, the system warns the user that the brain and/or its behavior(s) has one or more incompatibilities with the selected robot.

FIG. 9B shows that the user can also navigate to screen 900 by selecting the “edit brains” button 708 on the navigation page 700. In “edit brains” mode, screen 900 gives the user the option to delete each previously defined brain 904 with respective delete buttons 952a-952c. When the user finishes editing or creating a brain, the brain can be saved and/or stored in many physical and virtual places including but not limited to the local memory of the controlling device, on the robot (provided the robot has adequate storage capability), or a cloud computing device. In the case of a telepresence robot controlled by an attached mobile device (e.g., an iOS or Android device), the brain can be stored on the attached mobile device.

GUI-Based Brain Editor

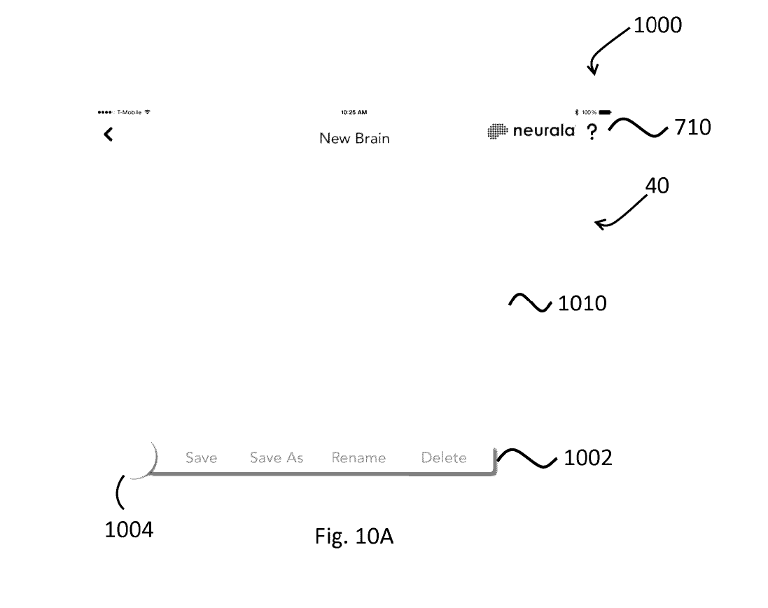

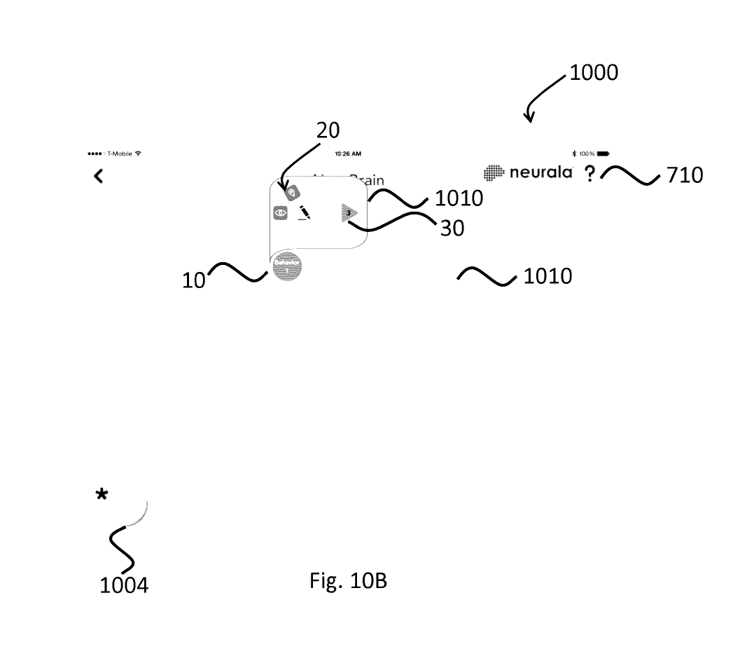

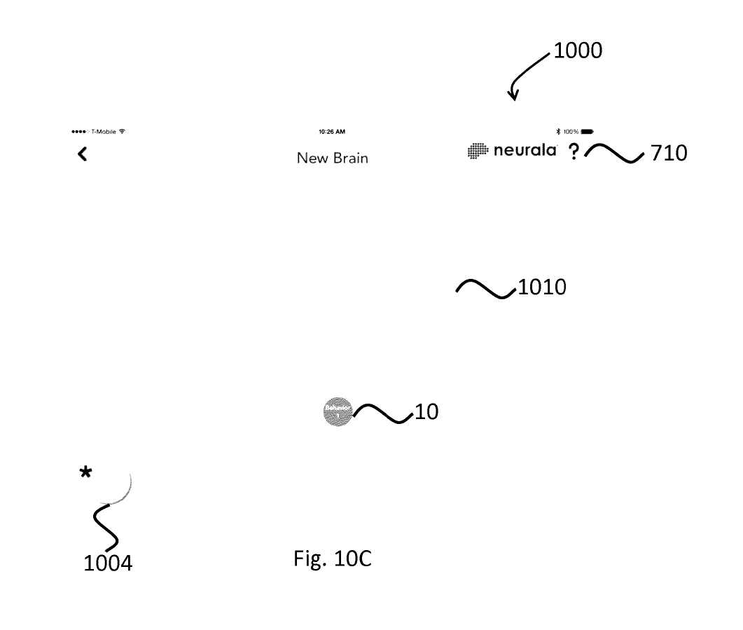

FIGS. 10A-10C show a brain editor screen 1000 of the GUI that enables the user to create or edit a brain 40. As described above with respect to FIGS. 3-5, each brain 40 include one or more behaviors 10, which in turn include one or more stimuli 20 and one or more response 30. The user can save, rename, or delete a brain 40 by selecting the appropriate button in a menu 1002 at the bottom of the brain editor screen 1000. The user can also navigate within the GUI using a menu button 1004.

The user can add a behavior 10 to the brain by clicking on an add behavior button 1010 as shown in FIG. 10A. Selecting or hovering over a particular behavior 10 may cause the GUI to display a pop-up window 1010 that shows the stimuli 20 and response(s) 30 defining the behavior 10 as shown in FIG. 10B. Behaviors 10 may be grouped to form personalities 45 and/or positioned in the brain 40 to establish weights or precedence among behaviors 10. For example, positioning a behavior 10 in the upper left corner of the brain 40, as shown in FIG. 10B, may increase the behavior's weight, whereas positioning a behavior 10 in the lower right corner of the brain 40, as shown in FIG. 10C, may decrease the behavior's weight.

GUI-Based Behavior Editor

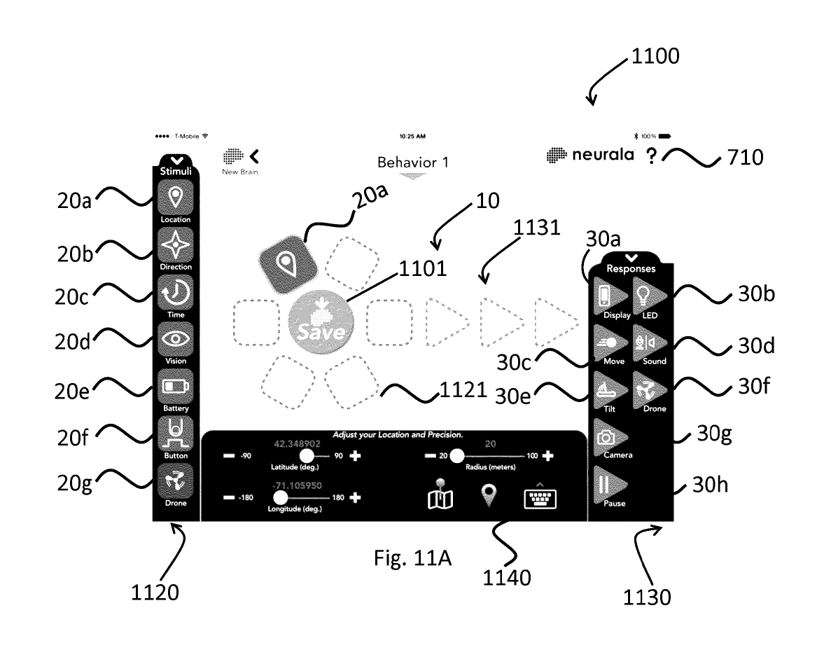

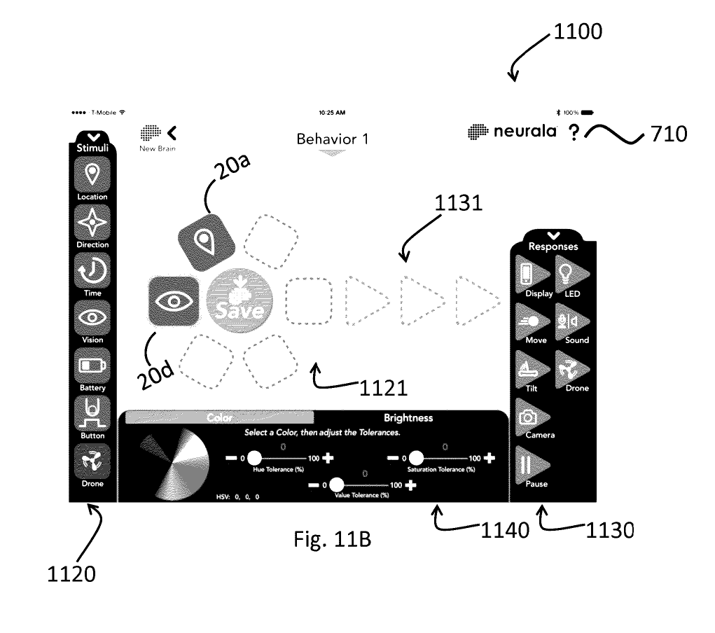

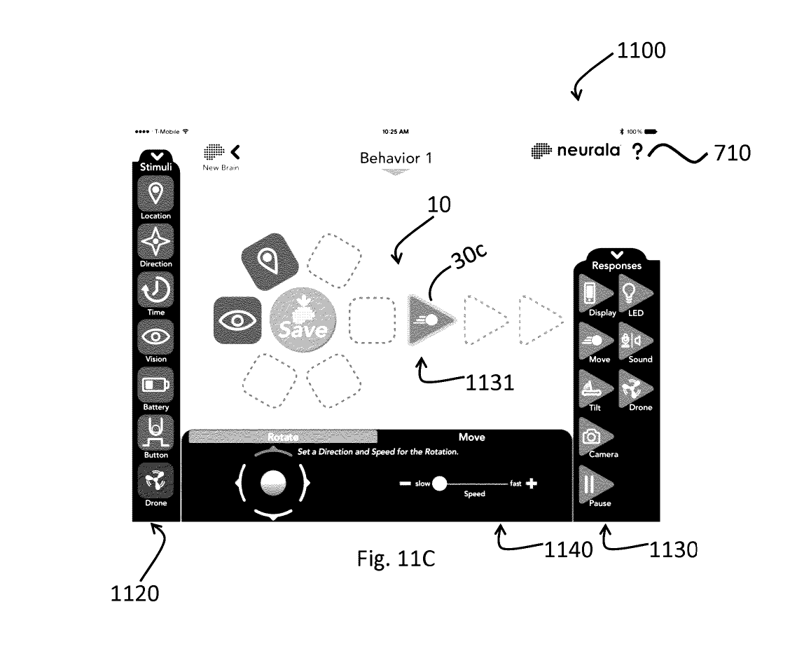

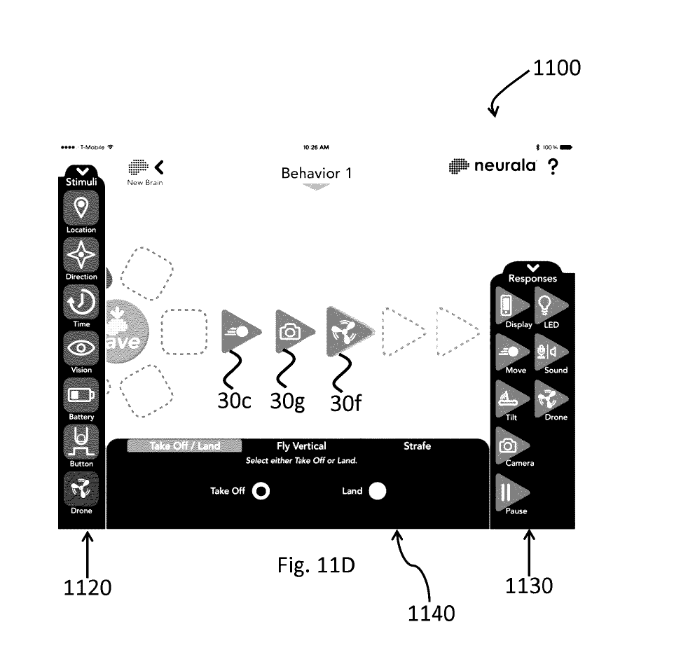

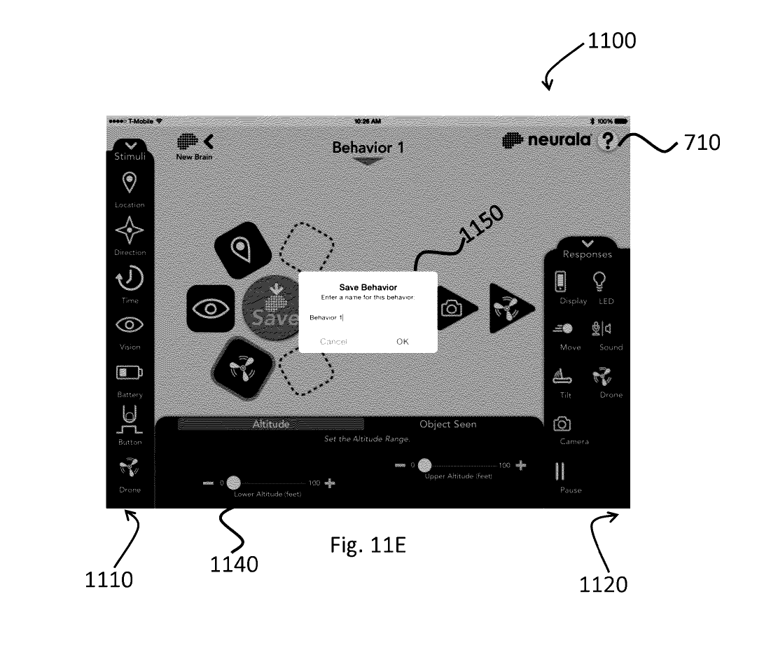

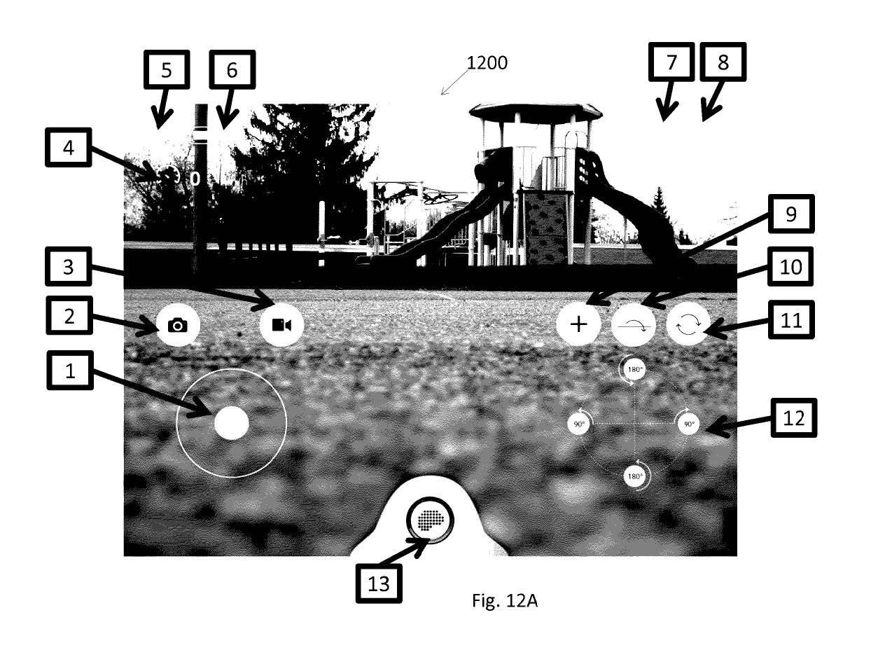

FIGS. 11A-11E show a Behavior Editor 1100 that enables viewing, adding, editing, and deleting of behaviors 10 for use in creating and editing brains 40. As shown in FIG. 11A, available stimuli 20 are represented on a stimulus panel 1120 and available responses 30 are represented on a response panel 1130 displayed on either side of the behavior 10 being created/edited. The available stimuli 20 and responses 30 may be retrieved from a library stored in a local or cloud-based memory.

To use the behavior editor 1100 to create or edit a behavior 10, the user selects a stimulus 20 by dragging it from the stimulus panel 1120 and dropping it into a stimulus input 1121 organized in a “petal” formation around a central circle “Save” button 1101, just like dendrites extending from a neuron body as shown in FIG. 3B. (Other arrangements are also possible.) Similarly, the user selects a response 30 by dragging it from the response panel 1130 and dropping it into a response input 1131 extending from the central circle “Save” button 1101, just like an axon extending from a neuron body as shown in FIG. 3B. The user can also set specific parameters for each stimulus and response using a stimulus/response editor 1140. For instance, for a location stimulus 20a, parameters may include longitude/latitude and radius (tolerance) of the GPS location as shown in FIG. 11A, a location on a specific map (e.g., Google map), a street name, or a location in a robot-generated map (unlabeled, or labeled—e.g., John's kitchen).

Stimuli can be linked by AND/OR logical conditions. Types of stimuli include but are not limited to: user input, such as touchscreen swipes, tilts, button pushes, etc.; machine vision (e.g., OpenCV), AI/ANN/DNN-related input (e.g., color, motion, face, object, and/or scene detection, robot-generated map); and quantitative sensor readings as well as device status from robot or controlling device, e.g. an iPad (e.g., WiFi signal strength and time of day). In some implementations there may be sub-dialogs for settings (e.g., at what battery level should a stimulus be activated). The setting may be displayed without the need to open the sub-dialog, or the user may open the sub-dialog for editing. Machine vision stimuli may include selection of particular colors the robot can detect to generate a response. Other implementations can include objects, people, scenes, either stored in the knowledge base of the robot, objects the user has trained the brain to recognize, objects that have been trained by other users, object learned by other robots, or knowledge bases available in cloud resources.

In this example, available stimuli include location 20a (e.g., GPS coordinates from a GPS receiver or coordinates from an inertial navigation unit), direction 20b (e.g., a heading from a compass or orientation from a gyroscope), time 20c (e.g., from a clock or timer), vision 20d (e.g., image data from a camera or other image sensor), battery 20e (e.g., a power supply reading from a power supply), user input 20f (e.g., from a button on the robot, the GUI, or another interface), and drone 20g (e.g., drone-specific stimuli, such as flight altitude). Additionally, other stimuli can be represented by the execution of another behavior.

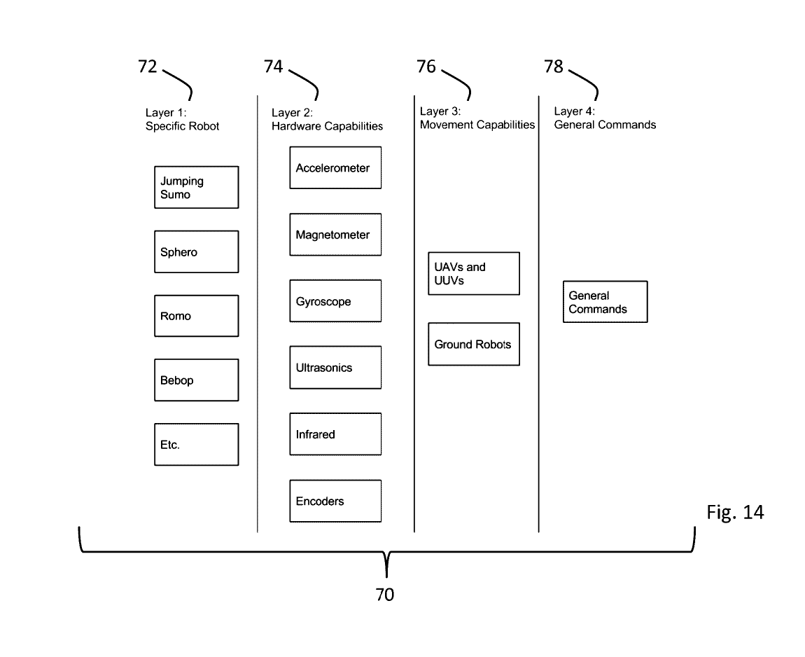

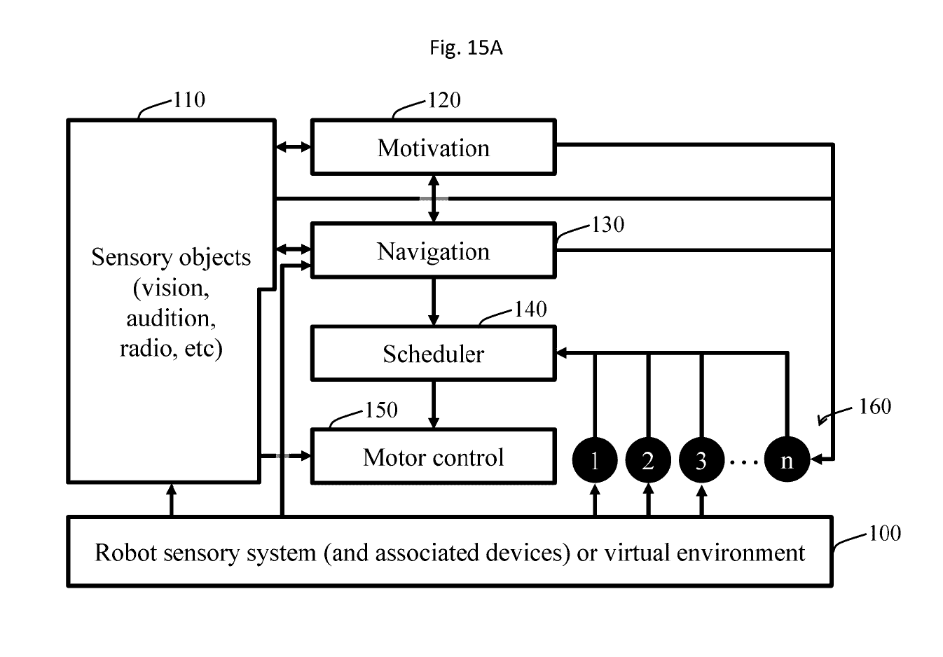

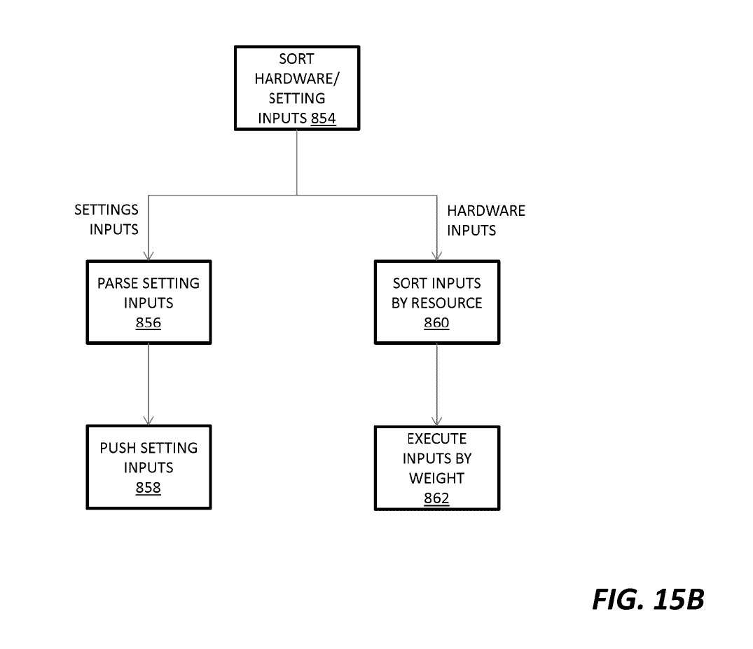

As shown in FIGS. 11A-11E, responses 30 are depicted as triangles arranged sequentially (in a line) and selectable from the sliding panel 1130 on the right. Once conditions to satisfy a stimulus (or multiple stimuli, e.g., three stimuli arranged in AND statements) are met, one or more responses are triggered. These responses can be executed sequentially, and while being executed, other stimuli processing can be prevented from gaining access to other stimuli using a scheduler as explained below with respect to FIGS. 15A and 15B. In other implementations, the sequence of responses can be broken by intervening stimuli. Responses are converted from robot-agnostic to robot-specific in software as explained below with respect to FIG. 14. For example, a “Move forward for 2 meters” on a ground robot, and the same command on a drone, will result in two very different set of motor commands for a robot, which will need to be handled in software to achieve equivalent behavioral results.

Responses 10 can include changing the status of the display of the robot (when available), specific movement of the robot, sounds (e.g., speech), tilt/rotations of the robot, picture/video, turning on/off lights (e.g., LED), pausing the robot, drone-specific operations (e.g., take off). In this example, available responses include display 30a)(e.g., if the robot has a screen, it can be a picture/video/image on the screen, color, text, etc.), light 30b (e.g., turn on a light-emitting diode (LED)), move 30c (e.g., trigger a walking or rolling motor), sound 30d (e.g., record sound with a microphone or emit sound with a speaker), tilt 30e (e.g., with an appropriate tilt actuator), drone 30f (e.g., fly in a certain direction, speed, or altitude), camera 30g (e.g., acquire still or video images with an image sensor), and pause 30h (e.g., stop moving). Additionally, custom actions can be available from the cloud, an on-line store, or other users.

Additionally, responses can be controlled by an AI/ANN/DNN. For example, a response 10 may be “Go to the kitchen,” where the knowledge of the spatial configuration of the environment is given by the robot mapping system (e.g., a DNN). Similarly, for the response “Find Bob”, the knowledge of Bob is given by an AI/ANN/DNN system. And for the response “Grasp the can of coke”, finding the object, reaching, and grasping can be given by an AI/ANN/DNN system.

Stimuli 20 and responses 30 can be re-arranged by dragging and dropping in the interface 1100, and a specific response can formed by the user recording specific movement by the robot performed under the control of the user, and saved as custom movements. For example, in FIGS. 11A and 11B, the user selects and adds the location stimulus 20a and the vision stimulus 20d to the behavior 10 and possibly adjust the parameters of these stimuli 20 using the stimuli/response editor 1140. In FIG. 11C, the user adds a Move Response 30c to the behavior 10 and selects the direction and duration of the movement using the stimuli/response editor 1140. FIG. 11D shows that the user has added the image acquisition response 30g and the Drone Response 30f, which enables the use to select take off or land using the stimuli/response editor 1140. And FIG. 11E shows a Save button 1150 that enables the user to name and save the behavior 10, which can then be used in a brain 40, exported, exchanged, and posted on a cloud server store.

Viewing Real-Time Robot Sensor Data and Operating the Robot

FIGS. 12A-12D illustrate an interface 1200 that provides the “Control” component of the GUI. This interface 1200 shows real-time image data acquired by an image sensor on a real or virtual robot connected to the system. The interface 1200/Control component may be used to operate a robot in real-time, e.g., by enabling the user to manually operate/drive the robot and engage complex functions from the drive screen (e.g., activate a brain, swap brains). The user can reach this interface 1200 by selecting the “see robot view” button 706 on the navigation page 700 of FIG. 7 or the select robot screen 800 of FIG. 8B.

In general, the interface 1200 may enable use of a dial format and/or swipe mode on a single screen. For instance, dials may provide indications of possible robot actions and/or easily recognizable symbols or icons (e.g., in addition to or instead of text). The user interface may give the user the ability to playback a behavior via button press, to show and/or hide a heads-up display (HUD), and/or to customize a HUD. In some implementations, supported controls may include but are not limited to: two-dial control; swipe control; two-dial control and swipe control on the same screen; tilt control (e.g., using the iPad sensors, move the robot in the direction of a device tilt); and voice commands. For swipe control, the robot may move in the direction of the swipe and may continue moving until the user lifts his or her swiping finger. The interface may enable the user to create a pattern, by swiping, for the robot to follow. (In some implementations the interface may show a trail on the screen in the direction of the swipe.) Similarly, vertical flying control altitude may utilize two finger gestures. Similarly, voice commands may encompass a plurality of actions. Other commands may include: device-type commands (e.g., forward, stop, right, left, faster), pet-related commands (e.g., come, heel), and other commands (e.g., wag, to move the iPhone in a Romotive Romo back and forth or to roll an Orbotix Sphero back and forth).

FIG. 12A shows display and control icons superimposed on image data from the robot connected to the system. In this example, a dial 1 enables the user to drive the robot. Other buttons in the interface enable actions such as take pictures 2 and videos 3. Elements of the display can show robot-specific telemetry information 4, Wi-Fi connectivity 5, battery level 6, help systems 7, and settings 8. Other items in the interface include a button 9 for adding or accessing robot-specific actions in the interface and buttons 10, 11, and 12 for causing the robot to move in certain directions. Additionally, a “brain” button 13 enables the user to turn on/off a specific brain that has been added to the robot or load a new brain.

FIG. 12B illustrates how to select a particular object for the robot to track or follow. The user engages a “follow” brain by pressing hand 1201 and selects an area 1210 surrounding the object, e.g., with a mouse or cursor or by pinching a touchscreen as illustrated by hands 1202a and 1202b. The user then selects a follow button 1212 as indicated by hand 1203. Once the user has selected the object and selected the follow button, the hardware-agnostic brain using an AI/ANN/DNN to recognize the object in image data from an image sensor on or in the robot. The hardware-agnostic brain issues commands to its motors that cause the robot to move in the direction of the object, e.g., by rolling, walking, hopping, or flying as appropriate given the robot's movement capabilities and the object's motion.

FIG. 12C depicts selection of a person while performing a sport stunt. The user selects the person to follow, and the response consists of keeping the image centered around the selected person by appropriately translating the shift of the bounding box into robot-specific motor controls. In FIG. 12D, a different brain is selected, whose purpose is to keep the center of the robot “gaze” around the object, either enabling the robot to “circumnavigate” the object, or centering the camera on the object while the operator maneuvers the robot (e.g., a sort of “autofocus” aid for the user). An “emergency stop” button 1205 allows the user to immediately stop all action on a mobile robot, such as a UAV, UUV, walking robot, or rolling robot. For a UAV, the emergency stop button 1205 may turn off the UAV's motors, causing the UAV to drop from the sky as a safety precaution.

In FIG. 12D, the brain comprises one behavior, with one stimulus being “when the selected object is in view” triggering the response “drive around the object for 360 degrees”. In another behavior, called “center behavior while driving”, there may be two stimuli: a first stimulus that is “when the selected object is in view” and a second stimulus that is “when the operator drives the robot” The response to these stimuli may be “modify drive command from the user so that the object is still centered in the image.” This could occur, for example, if the commands a drone to translate on the left, and the “center behavior while driving” is engaged, the left translation command is modified so that the drone translates to the left, but rotates to the right to keep the object in the center of focus.

Robot Knowledge Center

An exemplary user interface may provide a robot knowledge center that enables the user to label knowledge learned by the system, or by the collection of systems (e.g., a swarm of robots, or sensor network) connected to the user interface. Knowledge can include visual, auditory, or multimodal objects, locations in a map, the identity of a scene (or a collection of views of that scene), and higher-order knowledge extracted by more elementary one (e.g., conceptual knowledge derived by reasoning on sensor data). Example of higher, more complex knowledge can be derived by machine vision (e.g., OpenCV), AI/ANN/DNN algorithms that extract concept out of collections of simpler objects (e.g., heavy objects vs. light objects, animated objects vs. inanimate objects).

This robot knowledge center is accessible and editable in at least two ways. First, a user can access and/or edit the robot knowledge center during the process of building brains, e.g., in the process of using information from the robot knowledge center to define stimuli and/or responses. Second, while operating a robot with the GUI, a user can label new objects added to the robot knowledge center. Also, certain information from the knowledge center might be available in the Heads-Up Display (HUD) on the drive screen. For example, the HUD might show the map of the current room the robot is in, and a user could label the map via the interface.

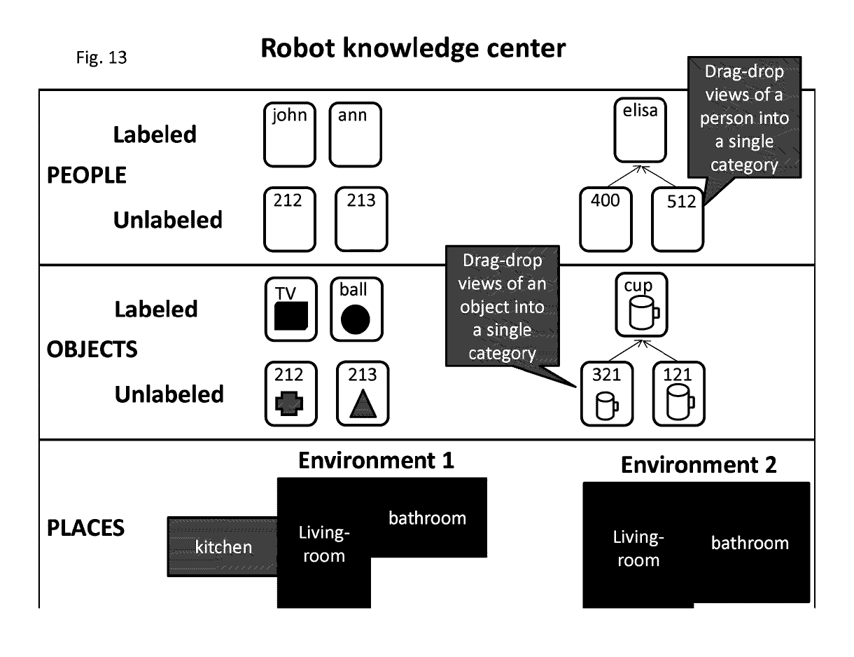

FIG. 13 shows an example robot knowledge center. In this example, the knowledge of the robot is divided in people, objects, and places. In this particular example, people and objects views are populated automatically, e.g., by the sensory module 110 (people, objects) and navigation module 130 (places) in the system of FIG. 15A, which is described in greater detail below. The user can select, e.g., via a touch screen on a tablet or a mouse, a specific view of a person or object, and provide a verbal or iconic label. Additionally, the user can take multiple views of an object, person, location (map), or a scene (e.g., multiple views of the kitchen) and group them in a single entity that combines all those views (e.g., several views of “John”, or a cup, or “John's kitchen”), e.g. via a drag/drop interface. The user can also edit the map generated by module 130 (places), by providing verbal and iconic (e.g., color) labels to specific areas of the environment mapped by the robot. These verbally or iconically defined objects, people, and places can be used by the stimulus/response system.

Generalized Application Program Interfaces (APIs) for Robot Control

In order to abstract the specific robot hardware away from the algorithms executed by the brain, the Software Development Kits (SDKs) and APIs provided by or acquired from robotics companies are wrapped into a generalized API as described below. In this generalized API, two different robots with a similar set of sensors and hardware configurations would have the same set of API calls. If the two robots are extremely different, such as a robot capable of flight and a robot incapable of flight, then a subset of algorithms may prevent the robot with the more restrictive hardware configuration from performing incompatible actions (e.g., flying). However, a robot capable of flight can still learn and execute the algorithms that are used for navigation in a 2D space. This is because algorithms that execute in 2D space can still be executed on a UAV by ignoring the vertical axis in 3D space.

FIG. 14 shows a process layout for constructing a generalized API 70 suitable for interfacing between a robot or robot-specific API and a hardware-agnostic robot brain. This generalized API 70 is constructed in four process layers. In some embodiments, a single block is taken from Layer 1 of the process layout of API 70 that represents choosing a specific robot 72. In some embodiments, one or more blocks can be taken from Layer 2, as this is the step that configures hardware capabilities 74 of the chosen robot 72. Layer 3 is determined by the robot's movement capabilities 76, such as for example whether the robot 72 is a ground based robot, a UAV or a UUV. The final process step for Layer 4 is added for all robots as general commands 78, regardless of the selections and/or combinations of the previous process layers.

The generalized API 70 shown in FIG. 14 can be implemented in any suitable computing device or combination of computing devices. For example, the control device for the generalized API can be a mobile device (e.g., an iOS/Android mobile device), a single board computer, or a laptop/desktop computer. When the first instance of a particular robot is added to the system, the developer may check the robot manufacturer's API and hook the robot manufacturer's API into the generalized API 70. The process of coupling a robot-specific API from a robot manufacturer to the generalized 70 may be simpler/easier if the robot-specific API is similar to a previously configured robot-specific API.

The first layer checks for the specific robot 72 that is being connected. Based off of this information, the protocol that will be used to communicate with the robot 72 is determined as some robots use Bluetooth, some use the User Datagram Protocol (UDP), some use the Transport Control Protocol (TCP), etc. This also determines how the robot 72 connects to the system. Finally, this step determines if this robot has any robot-specific commands cannot be generalized to other robotic platforms. For example, a Jumping Sumo has a couple of jumping options. For specific commands like these, the system provides an interface to allow developers to use them for specific projects, but with one major caveat: a warning is triggered when these robot-specific commands are used in standard algorithms, since these algorithms are intentionally generic.

The next layer search for hardware capabilities 74 of the robot 72, such as for example the available sensors on the robot 72 and sets up an API for those. Certain sensors can be used in place of each other (for example, infrareds and ultrasonic will both detect an object immediately in front of them). The algorithm itself defines this property, as it can be difficult to generalize if sensors can substituted without knowing the context in which they will be used. To continue with the previous example, if ultrasonic and infrared are only outputting a binary result (e.g., they see something or if they don't see something), then they can be reasonably substituted. However, if the algorithm requires an exact distance value as an output and this distance value is out of range for other sensors, then the algorithm can prevent substitution of sensors.

The next layer adds movement capabilities 76 of the robot 72, such as for example the number of dimensions (e.g. degree of freedom) the robot 72 can perform. Robots that can traverse underwater, such as for example UUVs or robots that can fly through the air, such as for example UAVs can maneuver in three dimensions. Ground robots, such as for example walking or wheeled robots can perform one-dimensional or two-dimensional algorithms.

The final layer adds generic commands 78 that apply to any robotics platform. For example, this layer adds one or more functions for connecting to and disconnecting from the robot 72, turning the robot 72 on and off, checking the robot's power supply, obtaining status information from the robot 72, etc.

The library, which may be stored in a memory or database, that handles generalizing across robotic structures has to make specific effort to abstract away the heterogeneous communication protocols. Each of these communication protocols has their own set of inherent properties. For example, UDP is connectionless and tends to be unreliable while TCP is connection-based and tends to be reliable. To abstract away these differences while maintaining a single API for all robots, helper objects are provided in the library to add some of those properties to communication protocols that don't have them inherently. For example, there is a reliable UDP stream to allow us to use communication paradigms that require reliability. This allows us to treat heterogeneous communication protocols as functionally similar which provides more flexibility for what algorithms can be used on robots.

One advantage of this approach is that the processor(s) can run the algorithms if the minimum hardware requirements are met or if sensors can be reasonably substituted for each other. This allows use of generalized algorithms that can be written on cheaper platforms with fewer features but that also run on more advanced platforms. However, there also exists the case where a developer is trying to run an algorithm on a robot that does not have the hardware to support it. Consider, for example, a ground-based robot with no camera is given an algorithm that requires it to fly around and record a video. To handle this case, each algorithm may provide a minimum hardware requirement.

Integration with Autonomous Behaviors (Autonomy)

The brains (collection of behaviors) described herein can be combined and associated with other forms of autonomous behaviors, such as autonomous sensory object recognition (such as but not limited to audition, vision, radio signals, LIDAR, or other point-cloud input, as well as any combination of the above sensors), in at least the following ways.

FIG. 15A depicts one example application where a (real or virtual) robot 100 is controlled by at least two autonomy modules (a sensory object module 110 and a motivation module 120) and several user-defined behaviors 160. The robot implements the autonomous, user-defined behaviors using various on-board sensors (e.g., cameras, accelerometer, gyro, IR, etc) that form a robot sensory system 100 and actuators/effectors (e.g., motors in tracks/propellers). The robot may also be linked to other sensors on associated hardware (e.g., a cell phone mounted on the robot, or a controlling iPad) that provide sensory input to an artificial robotic brain executing machine vision (e.g., OpenCV), AI, ANN, and DNN algorithms. These algorithms may be executed by:
a) a sensory module 110, which can be implemented, for instance, as a DNN processing video/audio/radio input, as well other sensory streams available from the robot (e.g., LIDAR, or other point cloud systems);
b) a motivation module 120, which can be implemented, for instance, as a spiking ANN to provide behavioral drives to the robot (e.g., curiosity to explore, need to recharge the battery, fear of colliding with an object, etc);
c) a navigation module 130, which can be implemented, for instance, as a continous-firing ANN learning the spatial layout of the environment and the location of the robot and objects in it.
   Module 100 also provides access to robot motors/effectors via a motor control module 150.

Additionally, the robotic brain may be configured with an arbitrary number of behaviors (e.g., pairs of stimulus/response sets 160). Behaviors can be created and edited by the user based on stimuli/responses defined above (e.g., stimuli directly based on reading and preprocessing of robot sensors). They can also be chosen from a collection of stimuli/responses directly generated by machine vision (e.g., OpenCV) AI/ANN/DNN algorithms in the sensory objects module 110 and navigation modules 130. For example, a particular behavior can be defined to include predetermined stimuli, such as time of the day (e.g., it's 2:00 PM as determined by the Robot processor, or the controlling cell phone), or a stimulus learned by the sensory system 110 (e.g. what “John” looks like). Similarly, a response associated with the behavior and executed in response to the stimulus can be defined from the navigation system 130 as “go to the kitchen.” The resulting behavior would cause the robot to go to the kitchen (as learned by the navigation system) when the robot sees John, as learned by elaborating video/audio sensory information and/or other signals (e.g., wireless signals originating from John's phone).

The robot may also include a scheduler 140 that regulates control of the motor control 150 by the autonomous system and the user-defined system. For instance, the scheduler 140 may issue commands to a given robotic effector (e.g., a motor) in a sequential fashion rather than all at once. Behaviors 160 take control of motor control 150 after interacting with the scheduler 140. Motor control 150 in turns can control robot effectors in 100.

In the example instantiation in FIG. 15A, at least two autonomy modules 110, 120 and several user-defined behaviors 160 can control robotic effectors via the scheduler 140. For example, the sensory module 110 could command the robot to make a camera movement to learn more about an object visual appearance with a right movement of the robot, the navigation system 130 may command the robot to explore the environment with a left movement of the robot, and the behavior 160 may command the robot to go backward following the appearance of a soccer ball. As an example instantiation, the scheduler can use a neural-like competitive cueing network (or ANN, or DNN) to appropriately sequence actions based on their relative importance and timing.

FIG. 15B is a flowchart that illustrates an example scheduling process executed by the scheduler 140. The scheduler 140 starts by sorting its inputs and then computing the relative weight of each input. Inputs can come from a variety of sources, including on-board sensors 100, off-board sensors, and user inputs, and the scheduler can scale from having one input to many. Generally speaking, the input sources include modules currently executing algorithms (e.g., the navigation module 130), the motivation of the robot (motivation module 120), command packets coming from a controller, and the currently executing brain (behaviors 160). Inputs with the highest weight execute, while inputs with lower weights that do not conflict with other inputs execute if they pass through a series of checks.

Each source coming into the scheduler 140 has more than one associated weight that gets combined into a final weight used by the scheduler 140. Each packet received by the scheduler 140 may have a specific weight for its individual command and a global weight provided by the scheduler 140 for that specific input. For example, if the scheduler 140 receives two motor commands from a controller—a first motor command with a global system weight of 0.2 and a specific weight of 0.4 and a second motor command with an global system weight of 0.1 and a specific weight of 0.9—it executes the second motor command as the combined weight of the second motor command is greater than that of the first motor command.

Global weights are typically determined by application developers and take into consideration priorities on the application level. For instance, a user input command may have priority over an algorithmically generated command (e.g., a STOP command from the drive screen may override a drive command generated by an AI/ANN/DNN). Likewise, global weights may take into account resource availability on a particular device.

Specific weights may be determined by the user of the application during the creation of the brain through positioning the behavior within the brain editor as described above with respect to FIGS. 4A, 4B, 5A, and 10A-10C. Within each behavior, the specific weights may be refined algorithmically based on possibility of concurrent uses of resources. Furthermore, these specific weights can be adjusted during runtime depending on actual resource availability at the time of scheduling.

Beyond the basic series of weights, the scheduler 140 also executes one or more sorting steps. The first step involves sorting commands that use discrete hardware resources from commands that affect things like settings and parameter adjustment (operation 854). Settings changes are parsed and checked for conflict (operation 856). If there are no conflicts, then all settings changes push (operation 858). If there are conflicts and there are weights that can be used to break the conflict, they are used. If everything is weighted identically and two settings conflict, than neither executes or a symmetry-breaking procedure may be applied (e.g., most-used behavior wins). Many of these settings packets can be executed simultaneously. Next, the packets that affect discrete system resources are further sorted based on the affected resource(s) (operation 860). Commands that can inherently affect each other but don't necessarily do so are kept together. For example, audio playback and audio recording may be kept in the same stream, as certain devices cannot record and playback and even if the option is available there are still constraints to deal with to avoid feedback.

For example, commands that affect motors may be grouped together. This allows decisions to be made while accounting for other packets that may conflict with the packet chosen to execute. In this particular implementation, If two packets have the potential to conflict but don't necessarily conflict, such as audio playback and audio recording, they may still be sent to the same group.

Once that packets that affect each individual hardware resource have been sorted into their own groups, the scheduler 140 determines which inputs to execute and the order in which to execute them (operation 862). The system checks if a resource is in use, and if it is, what was the weight of the packet that took control of the resource. In order to take control of a resource, a packet must have a higher weight than the packet that currently holds the resource. If it's a lower weight, it gets ignored and thrown away. If it's a higher weight, it takes control of the resource.

Different input sources can also communicate to each other and adjust the weights of the other subsystems. For instance, if the motivation system 120 is really interested in navigating, but it wants to navigate in a different direction, it can adjust the weights of the navigation packets being sent into the scheduler 140 by signaling the navigation system 130.

The scheduling process of FIG. 15B allows the robot to look for an object in the environment, then step backward as required by the user-defined behavior, then go on exploring the environment. In order to determine the relative importance of actions, the scheduler 140 may use the graphical placement of behaviors in the brain to determine the relative importance of each behavior in the brain. In other implementations, a user may be able to provide positive and/or negative reinforcement (e.g., during a training process with the robot) in order to train the robot to develop an understanding of which behaviors and/or responses to prioritize over others. In another implementation, an ANN/DNN autonomously prioritizes scheduling based on learning and experience. In another implementation, the user may manually define the importance of each behavior, e.g., determining which behavior gets the precedence over other behaviors when both behaviors comprise stimuli which would activate their two different sets of responses in reaction a single event. For example, when an image contains two stimuli (e.g., a face and the color red) which simultaneously activate two sets of responses, the user may manually pre-determine when behavior 1 is engaged and when behavior 2 may be performed if behavior 1 is not complete (e.g., the user may indicate that behavior 2 may interrupt behavior 1, may start after behavior 1 completes, and/or the like).

### CONCLUSION

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments can be implemented in any of numerous ways. For example, embodiments of designing and making the technology disclosed herein may be implemented using hardware, software or a combination thereof. When implemented in software, the software code can be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format. The computer may also receive input by visual observation (e.g., camera) or by a motion sensing device (e.g., Microsoft Knect).

Such computers may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

The various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above.

The terms “program” or “software” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A method for generating a hardware-agnostic behavior of at least one electronic device, the method comprising:
A) receiving, via a user interface, at least one stimulus selection from a user, the at least one stimulus selection corresponding to at least one stimulus detectable by the at least one electronic device;
B) receiving, via the user interface, at least one hardware-agnostic response selection from the user, the at least one hardware-agnostic response selection corresponding to at least one action to be performed by the at least one electronic device in response to the at least one stimulus; and
C) generating, via a processor operably coupled to the user interface, the hardware-agnostic behavior based on the at least one stimulus selection received in A) and the at least one hardware-agnostic response selection received in B).

2. The method of claim 1, wherein the at least one electronic device comprises at least one robot.

3. The method of claim 1, wherein the at least one stimulus is based at least in part on an output from a neural network.

4. The method of claim 1, wherein the at least one stimulus comprises sensing at least one of:
depressing a button;
swiping a touchscreen;
a change in attitude with a gyroscope;
acceleration with an accelerometer;
a change in battery charge;
a wireless signal strength;
a time of day;
a date;
passage of a predetermined time period;
magnetic field strength;
electric field strength;
stress;
strain;
position;
altitude;
speed;
velocity;
angular velocity;
trajectory;
a face, object, and/or scene with an imaging detector;
motion;
touch; and
sound and/or speech with a microphone.

5. The method of claim 1, wherein the at least one response is based at least in part on an output from a neural network.

6. The method of claim 5, wherein the output from the neural network comprises at least one of a visual object or an auditory object recognized by the neural network.

7. The method of claim 1, further comprising:
D) receiving, via the user interface, a selection of at least one particular electronic device to associate with the hardware-agnostic behavior generated in C); and
E) associating the hardware-agnostic behavior generated in C) with the at least one particular electronic device selected in D).

8. The method of claim 7, wherein E) comprises:
determining identifying information for the at least one particular electronic device, the identifying information including information about at least one sensor and/or at least one actuator associated with the at least one particular electronic device.

9. The method of claim 8, wherein E) comprises:
translating the hardware-agnostic behavior into hardware-specific instructions based at least in part on the identifying information; and
providing the hardware-specific instructions to the at least one particular electronic device.

10. The method of claim 1, wherein the at least one hardware-agnostic response selection comprises a sequence of actions to be performed by the at least one electronic device in response to at least one corresponding stimulus.

11. The method of claim 1, further comprising:
F) generating, via the processor, at least one other hardware-agnostic behavior based on at least one other stimulus selection and at least one other hardware-agnostic response selection; and
G) forming a hardware-agnostic personality based at least on the hardware-agnostic robot behavior and at least one other hardware-agnostic robot behavior.

12. A system for generating a hardware-agnostic behavior of at least one electronic device, the system comprising:
a user interface to receive:
at least one stimulus selection from a user, the at least one stimulus selection corresponding to at least one stimulus detectable by the at least one electronic device; and
at least one hardware-agnostic response selection from the user, the at least one hardware-agnostic response selection corresponding to at least one action to be performed by the at least one electronic device in response to the at least one stimulus;
a processor, operably coupled to the user interface, to generate the hardware-agnostic behavior based on the at least one stimulus selection and the at least one hardware-agnostic response selection; and
a communications port, operably coupled to the processor, to provide the hardware-agnostic behavior to the at least one electronic device.

13. The system of claim 12, further comprising:
a hardware translation component, operably coupled to the communications port, to translate the hardware-agnostic behavior into a set of hardware-specific input triggers to be sensed by the at least one electronic device and a set of hardware-specific actions in response to the set of hardware-specific input triggers to be performed by the at least one electronic device.

14. A computer-implemented method for loading at least one hardware-agnostic behavior between a first robot and a second robot, the method comprising:
receiving a request to load a first hardware-agnostic behavior onto the first robot;
retrieving the first hardware-agnostic behavior from at least one storage device, the first hardware-agnostic behavior defining at least one first hardware-agnostic robot response to at least one first hardware-agnostic robot sensor stimulus;
providing the first hardware-agnostic behavior to the first robot;
providing the first hardware-agnostic behavior to the second robot;
receiving a request to load a second hardware-agnostic behavior onto the first robot, the second hardware-agnostic behavior defining at least one second hardware-agnostic robot response to at least one second hardware-agnostic robot sensor stimulus;
retrieving the second hardware-agnostic behavior from the at least one storage device; and
providing the second hardware-agnostic behavior to the first robot.

15. The method of claim 14, further comprising:
providing the second hardware-agnostic behavior to the second robot.

16. The method of claim 14, wherein providing the second hardware-agnostic behavior to the first robot comprises replacing, in the robot, the first hardware-agnostic behavior with the second hardware-agnostic behavior.

17. A computer-implemented method for generating behaviors for a robot, the method comprising:
receiving, at a user interface, a selection of at least one stimulus to be sensed by the robot;
receiving, at the user interface, a selection of at least one response to be performed by the robot;
generating a behavior for the robot based at least in part on the at least one stimulus and the at least one response; and
rendering, via the user interface, the behavior as a behavior neuron comprising at least one dendrite representing the at least one stimulus and at least a portion of a neuron axon representing the at least one response.

18. The method of claim 17, wherein rendering the behavior comprises:
rendering the behavior neuron as at least one neuron of a plurality of neurons in a graphical representation of a brain.

19. The method of claim 18, wherein rendering the behavior neuron comprises:
rendering the at least one neuron in the graphical representation of the brain based on the nature of the behavior in relation to behavior centers of an animal brain.

20. A method of engaging at least one hardware-agnostic behavior to control at least one robot, the hardware-agnostic behavior comprising at least one action to be performed by the at least one robot in response to the at least one stimulus sensed by the at least one robot, the method comprising:
establishing a communications connection between the at least one robot and a graphical user interface (GUI);
receiving, via the GUI, an indication from a user regarding selection of the at least one hardware-agnostic behavior;
retrieving, from a memory operably coupled to the GUI, instructions for causing the at least one robot to operate according to the at least one hardware-agnostic behavior; and
executing the instructions with a processor operably coupled to the GUI so as to engage the at least one hardware-agnostic behavior to control the at least one robot.
